(19) United States
(12) Patent Application Publication
(10) Pub. No.: US 2025/0048292 A1
(43) Pub. Date: Feb. 6, 2025

(54) MULTIPLE TIMING ADVANCE CONFIGURATIONS FOR MULTIPLE TRANSMISSION RECEPTION POINT SCENARIOS

(71) Applicant: QUALCOMM Incorporated, San Diego, CA (US)

(72) Inventors: Fang YUAN, Beijing (CN); Yan ZHOU, San Diego, CA (US); Mostafa KHOSHNEVISAN, San Diego, CA (US); Shaozhen GUO, Beijing (CN); Tao LUO, San Diego, CA (US); Xiaoxia ZHANG, San Diego, CA (US); Peter GAAL, San Diego, CA (US); Junyi LI, Greentown, PA (US)

(21) Appl. No.: 18/714,470

(22) PCT Filed: Feb. 11, 2022
(86) PCT No.: PCT/CN2022/075995

§ 371 Date: May 30, 2024

(51) Int. Cl. H04W 56/00; H04W 72/0446; H04W 72/231; H04W 72/51; H04W 76/20

(52) U.S. Cl. CPC H04W 56/0045; H04W 72/0446; H04W 72/231; H04W 72/51; H04W 76/20

(57) ABSTRACT

Various aspects of the present disclosure generally relate to wireless communication. In some aspects, a user equipment (UE) may receive configuration information for a serving cell associated with a first transmission reception point (TRP) and for two or more other cells associated with two or more other TRPs, the serving cell and the two or more other cells associated with a same component carrier. The UE may receive a first timing advance configuration associated with the serving cell and a second one or more timing advance configurations associated with the two or more other cells. The UE may transmit an uplink communication in accordance with the first timing advance configuration or the second one or more timing advance configurations. Numerous other aspects are provided.

### FIELD OF THE DISCLOSURE

Aspects of the present disclosure generally relate to wireless communication and specifically, to techniques and apparatuses associated with multiple timing advance (TA) configurations for multiple transmission reception point (TRP) scenarios.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

In some wireless communication systems, a timing of the uplink frame may need to be adjusted in order to have alignment with a downlink frame in the time domain at a base station (for example, at a transmission reception point (TRP), a radio unit (RU), or a distributed unit (DU)). For example, an uplink transmission from a user equipment (UE) to the base station may take some time to reach the base station. In order to better align uplink frames and downlink frames at the base station, the base station may configure a UE to start an uplink frame an amount of time before a corresponding downlink frame. The amount of time may be referred to as a timing advance (TA). For example, a base station may transmit a TA command indicating a TA value. The TA value may be based at least in part on an amount of time an uplink transmission from the UE takes to reach the base station (for example, may be based at least in part on a distance between the UE and the base station). A TA configuration or a TA command may be indicated to the UE for a given component carrier (CC). In other words, a single TA configuration or TA command may be indicated by the base station for a CC and the UE may apply the TA configuration or TA command for all communications associated with the CC.

However, in some cases, multiple cells may be activated for the UE for a given CC. For example, in multi-TRP scenarios, at least one additional cell (for example, in addition to a serving cell) may be activated for the UE for a CC. For example, the UE may be configured with a set of physical cell identifiers (PCIs) for a CC, and two or more PCIs, from the set of PCIs, may be activated for the UE at a given time. In some cases, the two or more cells (for example, the two or more PCIs) may be associated with different timing alignments between uplink frames and downlink frames. For example, the two or more cells may be associated with TRPs that are physically located in different locations (for example, resulting in the amounts of time for an uplink transmission from the UE to reach the different TRPs being different) or may be associated with different uplink propagation delays, among other examples. However, because the CC may be associated with a single TA configuration or TA command from the network, the same uplink transmission timing may be used by the UE to transmit uplink communications to the two or more cells (for example, to the two or more TRPs). As a result, because the two or more cells (for example, the two or more TRPs) may be associated with different timing alignments between uplink frames and downlink frames, and because the UE applies the same uplink transmission timing for the two or more cells, communication performance associated with the two or more cells may be degraded. For example, communications with the two or more cells may experience inter-symbol interference that may result from the uplink frames and downlink frames not aligning in the time domain at the two or more cells (for example, at the two or more TRPs).

### SUMMARY

Some aspects described herein relate to a user equipment (UE) for wireless communication. The UE may include at least one processor and at least one memory, communicatively coupled with the at least one processor, that stores processor-readable code. The processor-readable code, when executed by the at least one processor, may be configured to cause the UE to receive configuration information for a serving cell associated with a first transmission reception point (TRP) and for two or more other cells associated with two or more other TRPs, the serving cell and the two or more other cells associated with a same component carrier. The processor-readable code, when executed by the at least one processor, may be configured to cause the UE to receive a first timing advance configuration associated with the serving cell and a second one or more timing advance configurations associated with the two or more other cells. The processor-readable code, when executed by the at least one processor, may be configured to cause the UE to transmit an uplink communication in accordance with the first timing advance configuration or the second one or more timing advance configurations.

Some aspects described herein relate to a method of wireless communication performed by a UE. The method may include receiving configuration information for a serving cell associated with a first TRP and for two or more other cells associated with two or more other TRPs, the serving cell and the two or more other cells associated with a same component carrier. The method may include receiving a first timing advance configuration associated with the serving cell and a second one or more timing advance configurations associated with the two or more other cells. The method may include transmitting an uplink communication in accordance with the first timing advance configuration or the second one or more timing advance configurations.

Some aspects described herein relate to a network entity for wireless communication. The network entity may include at least one processor and at least one memory, communicatively coupled with the at least one processor, that stores processor-readable code. The processor-readable code, when executed by the at least one processor, may be configured to cause the network entity to transmit, to a UE, configuration information for a serving cell associated with a first TRP and for two or more other cells associated with two or more other TRPs, the serving cell and the two or more other cells associated with a same component carrier. The processor-readable code, when executed by the at least one processor, may be configured to cause the network entity to transmit, to the UE, a first timing advance configuration associated with the serving cell and a second one or more timing advance configurations associated with the two or more other cells. The processor-readable code, when executed by the at least one processor, may be configured to cause the network entity to receive an uplink communication in accordance with the first timing advance configuration or the second one or more timing advance configurations.

Some aspects described herein relate to a method of wireless communication performed by a network entity. The method may include transmitting, to a UE, configuration information for a serving cell associated with a first TRP and for two or more other cells associated with two or more other TRPs, the serving cell and the two or more other cells associated with a same component carrier. The method may include transmitting, to the UE, a first timing advance configuration associated with the serving cell and a second one or more timing advance configurations associated with the two or more other cells. The method may include receiving an uplink communication in accordance with the first timing advance configuration or the second one or more timing advance configurations.

Some aspects described herein relate to a non-transitory computer-readable medium that stores a set of instructions for wireless communication by a UE. The set of instructions, when executed by one or more processors of the UE, may cause the UE to receive configuration information for a serving cell associated with a first TRP and for two or more other cells associated with two or more other TRPs, the serving cell and the two or more other cells associated with a same component carrier. The set of instructions, when executed by one or more processors of the UE, may cause the UE to receive a first timing advance configuration associated with the serving cell and a second one or more timing advance configurations associated with the two or more other cells. The set of instructions, when executed by one or more processors of the UE, may cause the UE to transmit an uplink communication in accordance with the first timing advance configuration or the second one or more timing advance configurations.

Some aspects described herein relate to a non-transitory computer-readable medium that stores a set of instructions for wireless communication by a network entity. The set of instructions, when executed by one or more processors of the network entity, may cause the network entity to transmit, to a UE, configuration information for a serving cell associated with a first TRP and for two or more other cells associated with two or more other TRPs, the serving cell and the two or more other cells associated with a same component carrier. The set of instructions, when executed by one or more processors of the network entity, may cause the network entity to transmit, to the UE, a first timing advance configuration associated with the serving cell and a second one or more timing advance configurations associated with the two or more other cells. The set of instructions, when executed by one or more processors of the network entity, may cause the network entity to receive an uplink communication in accordance with the first timing advance configuration or the second one or more timing advance configurations.

Some aspects described herein relate to an apparatus for wireless communication. The apparatus may include means for receiving configuration information for a serving cell associated with a first TRP and for two or more other cells associated with two or more other TRPs, the serving cell and the two or more other cells associated with a same component carrier. The apparatus may include means for receiving a first timing advance configuration associated with the serving cell and a second one or more timing advance configurations associated with the two or more other cells. The apparatus may include means for transmitting an uplink communication in accordance with the first timing advance configuration or the second one or more timing advance configurations.

Some aspects described herein relate to an apparatus for wireless communication. The apparatus may include means for transmitting, to a UE, configuration information for a serving cell associated with a first TRP and for two or more other cells associated with two or more other TRPs, the serving cell and the two or more other cells associated with a same component carrier. The apparatus may include means for transmitting, to the UE, a first timing advance configuration associated with the serving cell and a second one or more timing advance configurations associated with the two or more other cells. The apparatus may include means for receiving an uplink communication in accordance with the first timing advance configuration or the second one or more timing advance configurations.

Aspects generally include a method, apparatus, system, computer program product, non-transitory computer-readable medium, user equipment, base station, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example base station in communication with a user equipment (UE) in a wireless network in accordance with the present disclosure.

FIG. 3 is a diagram illustrating an example disaggregated base station architecture, in accordance with the present disclosure.

FIG. 4 illustrates an example logical architecture of a distributed radio access network (RAN), in accordance with the present disclosure.

FIG. 5 is a diagram illustrating an example of multiple transmission reception point (TRP) communication, in accordance with the present disclosure.

FIG. 6 is a diagram illustrating an example of a transmission timing configuration for a UE, in accordance with the present disclosure.

FIG. 7 is a diagram illustrating an example associated with multiple timing advance (TA) configurations for multiple TRP (multi-TRP) scenarios, in accordance with the present disclosure.

FIG. 8 is a diagram illustrating examples associated with overlapping uplink communications in multiple TA, multi-TRP scenarios, in accordance with the present disclosure.

FIG. 9 is a flowchart illustrating an example process performed, for example, by a UE associated with multiple timing advance configurations for multi-TRP scenarios, in accordance with the present disclosure.

FIG. 10 is a flowchart illustrating an example process performed, for example, by a network entity associated with multiple timing advance configurations for multi-TRP scenarios, in accordance with the present disclosure.

FIG. 11 is a diagram of an example apparatus for wireless communication in accordance with the present disclosure.

FIG. 12 is a diagram of an example apparatus for wireless communication in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to enabling multiple timing advance (TA) configurations for scenarios involving multiple transmission reception points (TRPs). Some aspects more specifically relate to a user equipment (UE) receiving (for example, from a network, a base station, a TRP, or a radio unit (RU)) a first timing advance configuration associated with a serving cell and a second one or more timing advance configurations respectively associated with two or more other cells, where the serving cell and the two or more other cells are associated with the same component carrier (CC). In some examples, the UE may receive configuration information (for example, from the network, a base station, a TRP, a central unit (CU), or a distributed unit (DU)) configuring the UE, for the same CC, with the first timing advance configuration associated with the serving cell and the second one or more timing advance configurations associated with the two or more other cells. In some aspects, the serving cell is associated with a first TRP and the two or more other cells are respectively associated with two or more other TRPs. In some examples, the UE may be configured, for the CC, with a physical cell identifier (PCI) for the serving cell and two or more PCIs for the two or more other cells, respectively (for example, where the two or more other cells are non-serving cells). In some aspects, the two or more timing advance configurations may include a separate, respective timing advance configuration for each cell of the two or more other cells. In some other aspects, the two or more timing advance configurations may include a single timing advance configuration that is associated with each cell included in the two or more other cells.

In some additional aspects, the UE may be scheduled to transmit a first uplink communication and to transmit a second uplink communication. The first uplink communication and the second uplink communication may at least partially overlap in the time domain (for example, due to the different timing advance configurations). In some aspects, if the first uplink communication and the second uplink communication are associated with the same TA group (TAG) identifier (for example, indicating that the first uplink communication and the second uplink communication are to be transmitted to the same cell or the same TRP), then the UE may reduce a transmission time of one of the first uplink communication or the second uplink communication so as to mitigate or eliminate the at least partial overlap in the time domain. In some aspects, the uplink transmission, from the first uplink transmission and the second uplink transmission, that is reduced (for example, that is not transmitted during time domain resources in which the first uplink communication and the second uplink communication overlapped as scheduled) may be based at least in part on which uplink communication was scheduled to be transmitted earlier in the time domain, or priorities of the first uplink communication and the second uplink communication, among other examples.

In some other aspects, if the first uplink communication and the second uplink communication are associated with different TAG identifiers (for example, indicating that the first uplink communication and the second uplink communication are to be transmitted to the different cells or different TRPs), then the UE may transmit the first uplink communication and the second uplink communication as scheduled (for example, without modifying a transmission time of either uplink communication). In other words, the UE may simultaneously transmit the first uplink communication and the second uplink communication during the time domain resources in which the first uplink communication and the second uplink communication overlap. In some aspects, the UE may simultaneously transmit the first uplink communication and the second uplink communication based at least in part on the UE being capable of simultaneous uplink transmissions, or the first uplink communication and the second uplink communication being compatible for simultaneous transmissions (for example, based on channels to be used to transmit the first uplink communication and the second uplink communication), among other examples. In some other aspects, where the first uplink communication and the second uplink communication are associated with different TAG identifiers, the UE may reduce a transmission time of one of the first uplink communication or the second uplink communication so as to mitigate or eliminate the at least partial overlap in the time domain (for example, based at least in part on the first uplink communication and the second uplink communication not being compatible for simultaneous transmissions, or the UE not supporting a capability associated with simultaneous transmissions). In such examples, the UE may the uplink transmission, from the first uplink transmission and the second uplink transmission, that is reduced may be based at least in part on which uplink communication was scheduled to be transmitted earlier in the time domain, priorities of the first uplink communication and the second uplink communication, or the TAG identifiers of the first uplink communication and the second uplink communication, among other examples.

Particular aspects of the subject matter described in this disclosure can be implemented to realize one or more of the following potential advantages. In some examples, the described techniques can be used to enable different TA values for different cells that are associated with the same CC (for example, in multiple TRP (multi-TRP) scenarios). For example, the UE may be enabled to apply different TA values for uplink transmissions to different cells associated with the same CC, thereby enabling the UE and the cells (for example, the TRPs) to synchronize symbols (for example, to synchronize uplink and downlink frames). Enabling the UE to synchronize symbols for multiple cells associated with the same CC may reduce inter-symbol interference that would have otherwise resulted from the uplink frames and downlink frames not aligning in the time domain at the different cells. Additionally, the UE may be enabled to handle overlapping uplink transmissions that may result from the UE applying different TA values in a multi-TRP scenario. For example, the UE may be enabled to identify whether to transmit two scheduled uplink communications that at least partially overlap in the time domain (for example, to simultaneously transmit the two scheduled uplink communications) or to reduce a time domain resource allocation for one of the two scheduled uplink communications so that the two uplink communications do not overlap. This may improve a performance or resource utilization of the UE (for example, by enabling the UE to simultaneously transmit two scheduled uplink transmissions in appropriate scenarios) and may reduce a likelihood of the two scheduled uplink transmissions causing interference (for example, in scenarios where simultaneous transmissions of the two scheduled uplink transmissions is not appropriate).

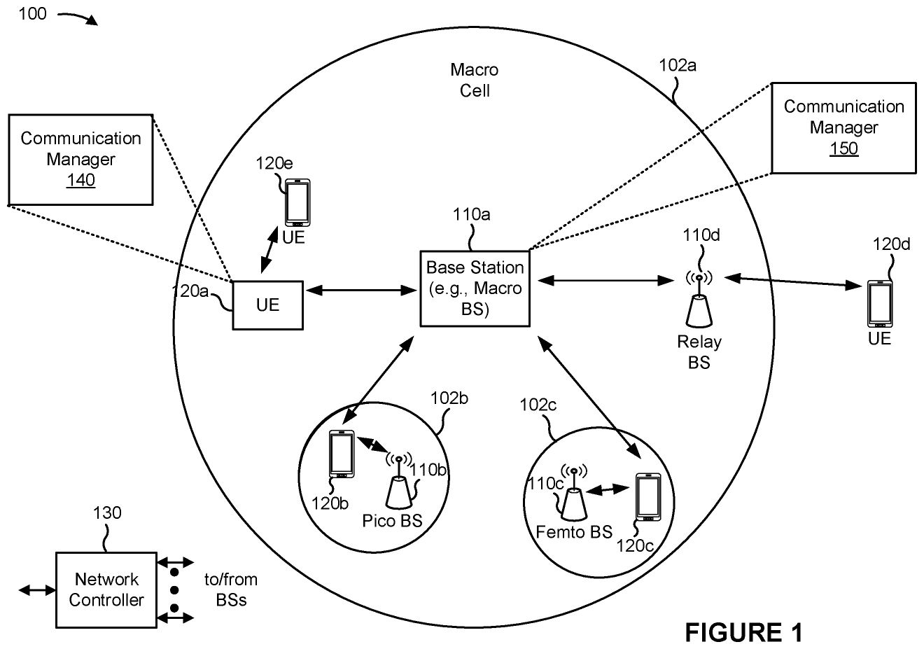

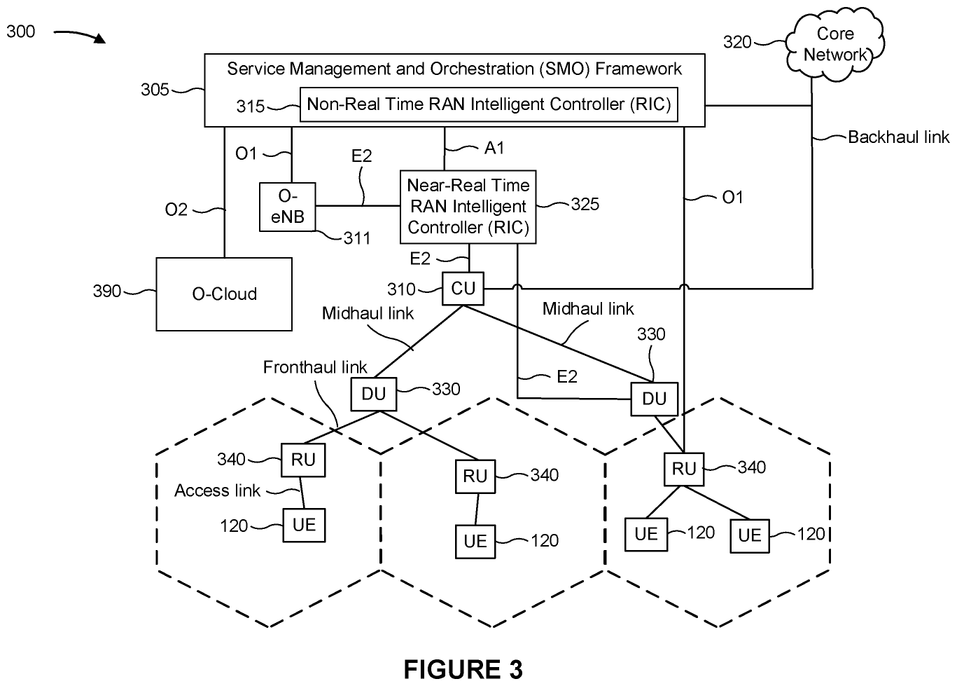

FIG. 1 is a diagram illustrating an example of a wireless network in accordance with the present disclosure. The wireless network 100 may be or may include elements of a 5G (for example, NR) network or a 4G (for example, Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), or other network entities. A base station 110 is an entity that communicates with UEs 120. A base station 110 (sometimes referred to as a BS) may include, for example, an NR base station, an LTE base station, a Node B, an eNB (for example, in 4G), a gNB (for example, in 5G), an access point, or a transmission reception point (TRP). Moreover, although the base station 110 is depicted as an integral unit in FIG. 1, aspects of the disclosure are not so limited. In some other examples, the functionality of the base station 110 may be disaggregated as described in more detail in connection with FIGS. 3-5, such as in accordance with an open radio access network (RAN) (O-RAN) architecture. As described herein, a network entity, which may be referred to as a “node,” a “network node,” or a “wireless node,” may be a base station (for example, base station 110), a relay device, a network controller, an apparatus, a device, a computing system, one or more components of any of these, or another processing entity configured to perform one or more aspects of the techniques described herein. For example, a network entity may be a base station. A network entity may be an aggregated base station or one or more components of a disaggregated base station, such as a TRP, an RU, a DU, or a CU, among other examples. Each base station 110 may provide communication coverage for a particular geographic area. In the Third Generation Partnership Project (3GPP), the term “cell” can refer to a coverage area of a base station 110 or a base station subsystem serving this coverage area, depending on the context in which the term is used.

A base station 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station.

The wireless network 100 may be a heterogeneous network that includes base stations 110 of different types, such as macro base stations, pico base stations, femto base stations, or relay base stations. These different types of base stations 110 may have different transmit power levels, different coverage areas, or different impacts on interference in the wireless network 100. For example, macro base stations may have a high transmit power level (for example, 5 to 40 watts) whereas pico base stations, femto base stations, and relay base stations may have lower transmit power levels (for example, 0.1 to 2 watts). In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (for example, three) cells. A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

In some examples, a cell may not necessarily be stationary, and the geographic area of the cell may move in accordance with the location of a base station 110 that is mobile (for example, a mobile base station). In some examples, the base stations 110 may be interconnected to one another or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a base station 110 or a UE 120) and send a transmission of the data to a downstream station (for example, a UE 120 or a base station 110). A relay station may be a UE 120 that can relay transmissions for other UEs 120. In the example shown in FIG. 1, the BS 110d (for example, a relay base station) may communicate with the BS 110a (for example, a macro base station) and the UE 120d in order to facilitate communication between the BS 110a and the UE 120d. A base station 110 that relays communications may be referred to as a relay station, a relay base station, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a base station, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a base station 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the base station 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHZ,” if used herein, may broadly represent frequencies that may be less than 6 GHZ, may be within FR1, or may include mid-band frequencies. Further, unless specifically stated otherwise, it should be understood that the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive configuration information for a serving cell associated with a first TRP and for two or more other cells associated with two or more other TRPs, the serving cell and the two or more other cells associated with a same component carrier; receive a first timing advance configuration associated with the serving cell and a second one or more timing advance configurations associated with the two or more other cells; and transmit an uplink communication in accordance with the first timing advance configuration or the second one or more timing advance configurations. Additionally or alternatively, the communication manager 140 may perform one or more other operations described herein.

In some aspects, the base station 110 may include a communication manager 150. As described in more detail elsewhere herein, the communication manager 150 may transmit, to a UE, configuration information for a serving cell associated with a first TRP and for two or more other cells associated with two or more other TRPs, the serving cell and the two or more other cells associated with a same component carrier; transmit, to the UE, a first timing advance configuration associated with the serving cell and a second one or more timing advance configurations associated with the two or more other cells; and receive an uplink communication in accordance with the first timing advance configuration or the second one or more timing advance configurations. Additionally or alternatively, the communication manager 150 may perform one or more other operations described herein.

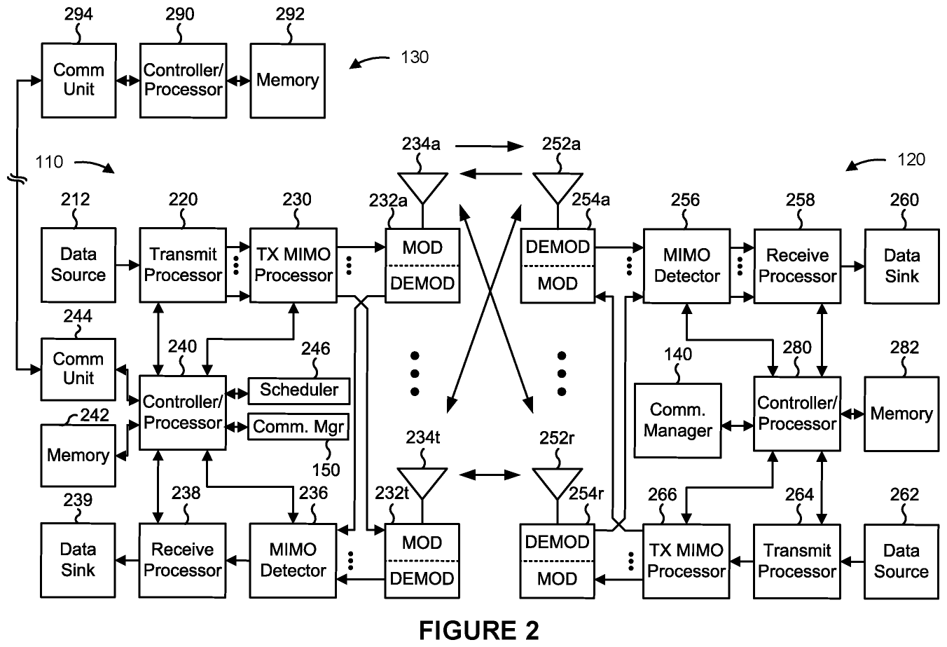

FIG. 2 is a diagram illustrating an example base station in communication with a UE in a wireless network in accordance with the present disclosure. The base station may correspond to the base station 110 of FIG. 1. Similarly, the UE may correspond to the UE 120 of FIG. 1. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the base station 110 or other base stations 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the base station 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

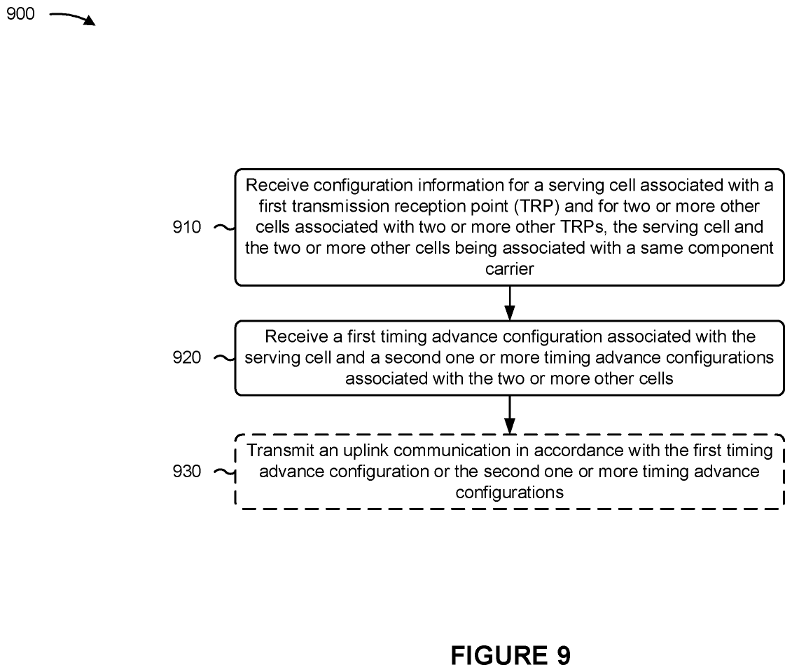

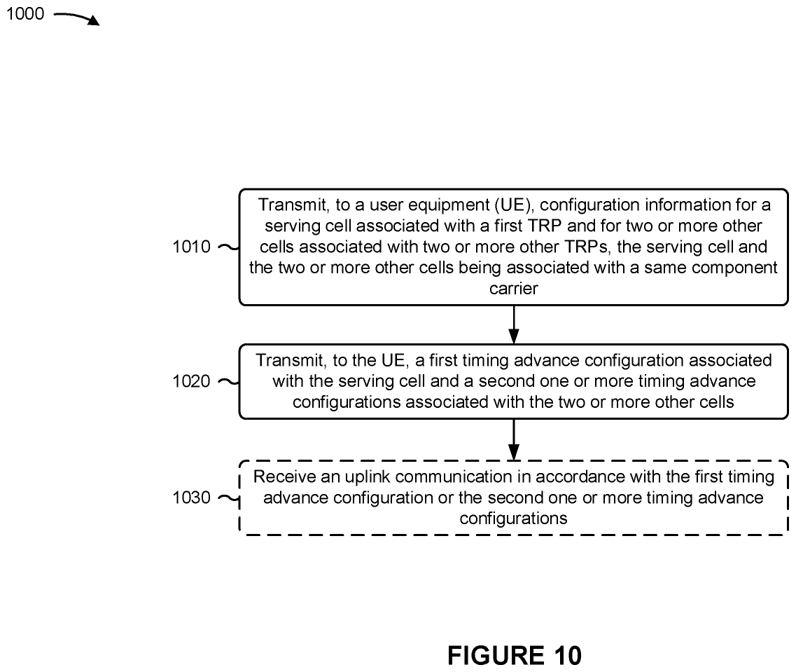

The controller/processor 240 of the base station 110, the controller/processor 280 of the UE 120, or any other component(s) of FIG. 2 may perform one or more techniques associated with multiple TA configurations for multi-TRP scenarios, as described in more detail elsewhere herein. For example, the controller/processor 240 of the base station 110, the controller/processor 280 of the UE 120, or any other component(s) of FIG. 2 may perform or direct operations of, for example, process 900 of FIG. 9, process 1000 of FIG. 10, or other processes as described herein. The memory 242 and the memory 282 may store data and program codes or processor-readable codes for the base station 110 and the UE 120, respectively. In some examples, the memory 242 or the memory 282 may include a non-transitory computer-readable medium storing one or more instructions (for example, code, processor-readable code, or program code) for wireless communication. For example, the one or more instructions, when executed (for example, directly, or after compiling, converting, or interpreting) by one or more processors of the base station 110 or the UE 120, may cause the one or more processors, the UE 120, or the base station 110 to perform or direct operations of, for example, process 900 of FIG. 9, process 1000 of FIG. 10, or other processes as described herein. In some examples, executing instructions may include running the instructions, converting the instructions, compiling the instructions, or interpreting the instructions, among other examples.

In some aspects, the UE 120 includes means for receiving configuration information for a serving cell associated with a first TRP and for two or more other cells associated with two or more other TRPs, the serving cell and the two or more other cells associated with a same component carrier; means for receiving a first timing advance configuration associated with the serving cell and a second one or more timing advance configurations associated with the two or more other cells; or means for transmitting an uplink communication in accordance with the first timing advance configuration or the second one or more timing advance configurations. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the a network entity includes means for transmitting, to a UE, configuration information for a serving cell associated with a first TRP and for two or more other cells associated with two or more other TRPs, the serving cell and the two or more other cells associated with a same component carrier; means for transmitting, to the UE, a first timing advance configuration associated with the serving cell and a second one or more timing advance configurations associated with the two or more other cells; or means for receiving an uplink communication in accordance with the first timing advance configuration or the second one or more timing advance configurations. The means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station.

An aggregated base station may be configured to utilize a radio protocol stack that is physically or logically integrated within a single RAN node (for example, within a single device or unit). A disaggregated base station may be configured to utilize a protocol stack that is physically or logically distributed among two or more units (such as a CU, one or more DUs, or one or more RUs). In some examples, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as through F1 interfaces. Each of the DUs 330 may communicate with one or more RUs 340 via respective fronthaul links. Each of the RUs 340 may communicate with one or more UEs 120 via respective RF access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which may also be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts radio frequency (RF) processing functions or low-PHY layer functions, such as performing an FFT, performing an iFFT, digital beamforming, or PRACH extraction and filtering, among other examples, based at least in part on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

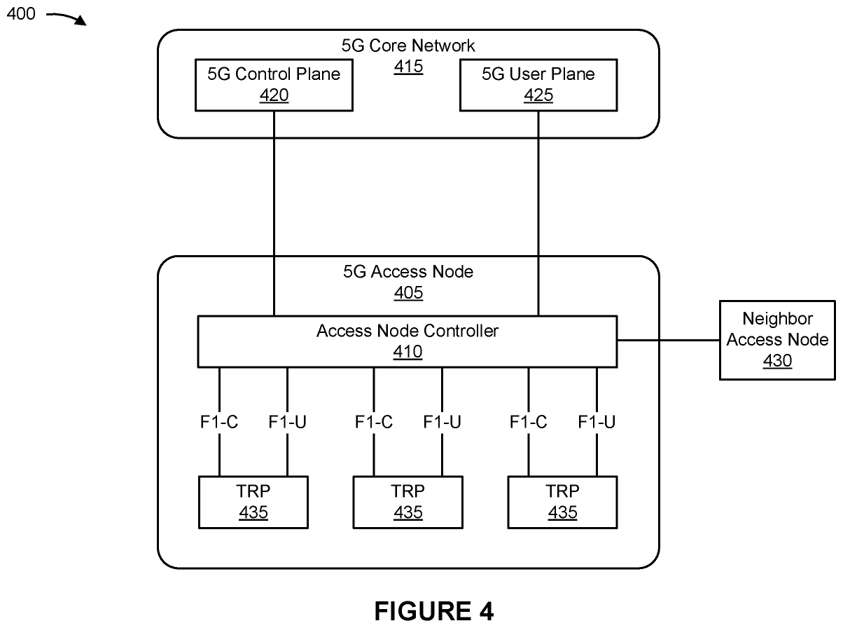

FIG. 4 illustrates an example logical architecture of a distributed RAN 400, in accordance with the present disclosure. A 5G access node 405 may include an access node controller 410. The access node controller 410 may be a CU of the distributed RAN 400. In some examples, a backhaul interface to a 5G core network 415 may terminate at the access node controller 410. The 5G core network 415 may include a 5G control plane component 420 and a 5G user plane component 425 (for example, a 5G gateway that includes both the 5G control plane component 420 and the 5G user plane component 425), and a backhaul interface for one or both of the 5G control plane and the 5G user plane may terminate at the access node controller 410. Additionally or alternatively, a backhaul interface to one or more neighbor access nodes 430 (for example, another 5G access node 405 or an LTE access node) may terminate at the access node controller 410.

The access node controller 410 may be associated with or may communicate with one or more TRPs 435 (for example, via an F1 Control (F1-C) interface or an F1 User (F1-U) interface). In some cases, a TRP 435 may be referred to as a cell, a panel, an antenna array, or an array. Each TRP 435 may be a DU or an RU of the distributed RAN 400. A TRP 435 may be connected to a single access node controller 410 or to multiple access node controllers 410. In some examples, a TRP 435 may correspond to a base station described above in connection with FIG. 1, 2, or 3. For example, different TRPs 435 may be included in different respective base stations. Additionally or alternatively, multiple TRPs 435 may be included in a single base station. In some aspects, a disaggregated base station may include a CU (for example, access node controller 410) or one or more DUs (for example, one or more TRPs 435). In some examples, a functional split of base station functionality between an access node controller 410 (for example, a CU), and a TRP 435 (for example, a DU or an RU) may be defined, such as by the 3GPP. For example, a PDCP layer, an RLC layer, or a MAC layer may be configured to terminate at the access node controller 410 or at a TRP 435.

In some examples, multiple TRPs 435 may transmit communications (for example, the same communication or different communications) in a same transmission time interval (TTI) (for example, a slot, a mini-slot, a subframe, or a symbol) or in different TTIs using different quasi co-location (QCL) relationships (for example, different spatial parameters, different transmission configuration indicator (TCI) states, different precoding parameters, or different beamforming parameters). In some aspects, a TCI state may be used to indicate one or more QCL relationships. Each TRP 435 may be configured to individually (for example, using dynamic selection) or jointly (for example, using joint transmission with one or more other TRPs 435) serve traffic to a UE 120.

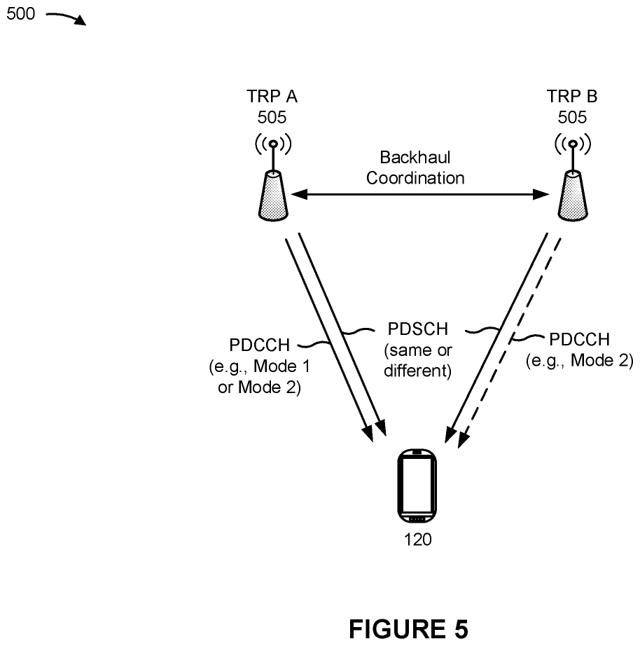

FIG. 5 is a diagram illustrating an example of multi-TRP communication 500, in accordance with the present disclosure. Multi-TRP communication 500 may sometimes referred to as multi-panel communication. As shown in FIG. 5, multiple TRPs 505 may communicate with the same UE 120. A TRP 505 may correspond to a TRP 435 described above in connection with FIG. 4.

The multiple TRPs 505 (shown as TRP A and TRP B) may communicate with the same UE 120 in a coordinated manner (for example, using coordinated multipoint transmissions) to improve reliability or increase throughput. The TRPs 505 may coordinate such communications via an interface between the TRPs 505 (for example, a backhaul interface or an access node controller 410). The interface may have a smaller delay or higher capacity when the TRPs 505 are co-located at the same base station 110 (for example, when the TRPs 505 are different antenna arrays or panels of the same base station 110), and may have a larger delay or lower capacity (as compared to co-location) when the TRPs 505 are located at different base stations 110. The different TRPs 505 may communicate with the UE 120 using different QCL relationships (for example, different TCI states), different demodulation reference signal (DMRS) ports, or different layers (for example, of a multi-layer communication).

In a first multi-TRP transmission mode (for example, Mode 1), a single physical downlink control channel (PDCCH) may be used to schedule data communications for a single physical downlink shared channel (PDSCH) or a single physical uplink shared channel (PUSCH). In such examples, multiple TRPs 505 (for example, TRP A and TRP B) may transmit communications to the UE 120 on the same PDSCH or PUSCH. For example, a communication may be transmitted using a single codeword with different spatial layers for different TRPs 505 (for example, where one codeword maps to a first set of layers transmitted by a first TRP 505 and maps to a second set of layers transmitted by a second TRP 505). As another example, a communication may be transmitted using multiple codewords, where different codewords are transmitted by different TRPs 505 (for example, using different sets of layers). In either case, different TRPs 505 may use different QCL relationships (for example, different TCI states) for different DMRS ports corresponding to different layers. For example, a first TRP 505 may use a first QCL relationship or a first TCI state for a first set of DMRS ports corresponding to a first set of layers, and a second TRP 505 may use a second (different) QCL relationship or a second (different) TCI state for a second (different) set of DMRS ports corresponding to a second (different) set of layers. In some examples, a TCI state in downlink control information (DCI) (for example, transmitted on the PDCCH, such as DCI format 1_0 or DCI format 1_1) may indicate the first QCL relationship (for example, by indicating a first TCI state) and the second QCL relationship (for example, by indicating a second TCI state). The first and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (for example, Mode 1). The Mode 1 described above may be referred to as a single DCI (sDCI) multi-TRP mode.

In a second multi-TRP transmission mode (for example, Mode 2), multiple PDCCHs may be used to schedule downlink or uplink data communications for multiple corresponding PDSCHs or multiple corresponding PUSCHs (for example, one PDCCH for each PDSCH or PUSCH). In such examples, a first PDCCH may schedule a first codeword to be transmitted by a first TRP 505, and a second PDCCH may schedule a second codeword to be transmitted by a second TRP 505. Furthermore, first DCI (for example, transmitted by the first TRP 505) may schedule a first PDSCH communication associated with a first set of DMRS ports with a first QCL relationship (for example, indicated by a first TCI state) for the first TRP 505, and second DCI (for example, transmitted by the second TRP 505) may schedule a second PDSCH communication associated with a second set of DMRS ports with a second QCL relationship (for example, indicated by a second TCI state) for the second TRP 505. In such examples, DCI (for example, having DCI format 1_0 or DCI format 1_1) may indicate a corresponding TCI state for a TRP 505 corresponding to the DCI. The TCI field of a DCI indicates the corresponding TCI state (for example, the TCI field of the first DCI indicates the first TCI state and the TCI field of the second DCI indicates the second TCI state). The Mode 2 described above may be referred to as a multiple DCI (mDCI) multi-TRP mode,

For example, in some wireless communications systems, a UE may be configured with multi-DCI based multi-TRP operation. Multi-DCI based multi-TRP operation configuration allows the UE to concurrently communicate via multiple TRPs. For example, a UE may receive, from a first TRP, first DCI in a first PDCCH, where the first DCI schedules a first PDSCH or PUSCH to be transmitted by the first TRP. Similarly, the UE may receive, from a second TRP, second DCI in a second PDCCH, where the second DCI schedules a second PDSCH or PUSCH to be transmitted by the second TRP. Notably, the first and second PDSCHs or PUSCHs can be non-overlapping, partially overlapping, or fully overlapping. In the case of a partial overlapping or a full overlapping, demodulation reference signal (DMRS) symbols can be aligned and different code division multiplexing (CDM) groups can be used in association with communication of the first and second PDSCHs or PUSCHs. In association with monitoring DCIs transmitted from different TRPs, the UE may monitor PDCCH candidates in PDCCH monitoring occasions in different control resource sets (CORESETs), as configured by the network. In the case of multi-DCI based multi-TRP operation described above, differentiation of TRPs at the UE-side may be on the basis of CORESET groups. For example, each CORESET may be associated with a higher layer (for example, an RRC layer) index, meaning that CORESETs can be grouped based on higher layer indices signaled on a per CORESET basis. These higher layer indices may be used to group CORESETs into multiple groups. For example, CORESETs with a higher layer index of 0 are included in first CORESET group, and CORESETs with a higher layer index of 1 are included in a second CORESET group. Here, the first CORESET group and the second CORESET group each correspond to a different TRP. In other words, CORESETs in a given group are associated with a particular TRP.

In some examples, for inter-cell multi-TRP operation, one additional cell may be activated for a UE (for example, in addition to a serving cell) for a given component carrier (CC). For example, for a CC, a physical cell identifier (PCI) for the serving cell may be activated and one additional PCI (for example, in addition to the serving cell PCI) may be supported by the UE for the CC. The additional PCI (for example, the additional cell) may be associated with one or more TCI states that are activated for the CC (for example, for a PDSCH, PUSCH, PUCCH or PDCCH associated with the CC). For example, for the CC, a first PCI may be associated with one or more activated TCI states for the PDSCH/PDCCH/PUSCH/PUCCH of the CC and a first CORESET pool index (for example, a first (′ORESETPoolIndex). A second PCI may be associated with one or more activated TCI states for the PDSCH/PDCCH/PUSCH/PUCCH of the CC and a second CORESET pool index (for example, a second (′ORESETPoolIndex) (for example, in a multi-DCI multi-TRP operation).

The network (for example, a base station, a TRP, a CU, or a DU) may configure a set of PCIs for a UE for a given CC. In some examples, the network may be enabled to configure a quantity (for example, a maximum quantity), X, of PCIs for the UE for a CC. The value of X may be based at least in part on a capability of the UE. For example, the UE may report, to the network, value(s) of X that can be supported by the UE. In some examples, a single value of X is reported as a UE capability (for example, for any possible synchronization signal block (SSB) time domain position and periodicity). In some other examples, at least two independent X values (X₁, X₂) are reported as a UE capability for at least two different assumptions on SSB time domain position and periodicity with respect to a serving cell SSB. For example, X₁ may be associated with a quantity of PCIs that can be configured for a given CC when each configuration of SSB time domain positions and periodicity of the additional PCIs is the same as the SSB time domain positions and periodicity of the serving cell PCI. X₂ may be associated with a quantity of PCIs that can be configured for a given CC when the configurations of SSB time domain positions and periodicity of the additional PCIs are different than the SSB time domain positions and periodicity of the serving cell PCI. Example values for X, X₁, or X₂, include 0, 1, 2, 3, or 7, among other examples. In some examples, the reported value for X, X₁, or X₂ may be for a given frequency band or frequency range (for example, the UE may report a value for X, X₁, or X₂, for each frequency band supported by the UE). In other words, the UE may support different values for X, X₁, or X₂ for FR1 versus FR2, among other examples.

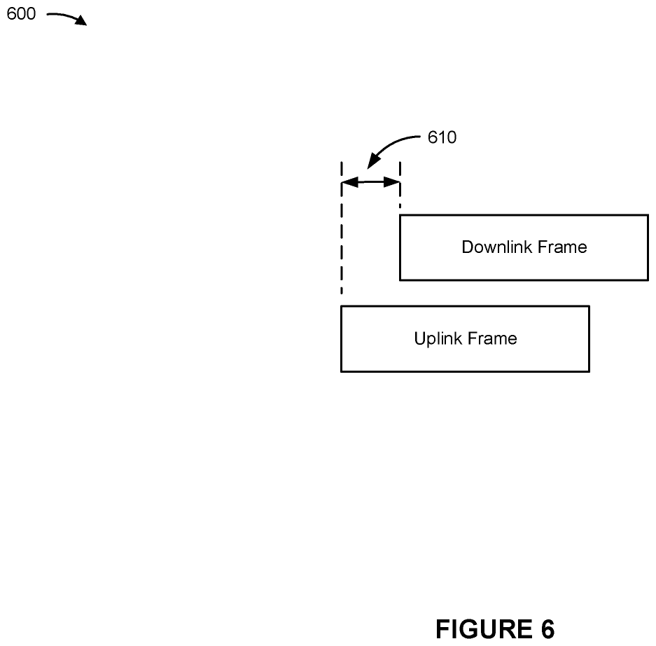

FIG. 6 is a diagram illustrating an example of a transmission timing configuration 600 for a UE 120, in accordance with the present disclosure. In some wireless communication systems, a timing of the uplink frame may need to be adjusted in order to have alignment with a downlink frame in time domain at a base station (for example, at a TRP, an RU, or a DU). For example, an uplink transmission from the UE 120 to the base station may take some time to reach the base station. In order to better align uplink frames and downlink frames at the base station, the base station may configure a UE 120 to start an uplink frame an amount of time 610 before a corresponding downlink frame.

As shown in FIG. 6, a UE 120 may receive a timing advance configuration for uplink transmissions. For example, a base station may transmit a TA command indicating a TA value. The TA command may be transmitted as part of a random access channel (RACH) procedure (for example, in a random access response (RAR) message of a RACH procedure). In some examples, the TA command may be indicated in a MAC-CE message. The TA value may be based at least in part on an amount of time an uplink transmission from the UE 120 takes to reach the base station (for example, may be based at least in part on a distance between the UE 120 and the base station). A TA configuration or a TA command may be indicated to the UE 120 for a given CC. In other words, a single TA configuration or TA command may be indicated by the base station for a CC and the UE may apply the TA configuration or TA command for all communications associated with the CC.

The UE 120 may determine the amount of time 610 before the start of a downlink frame that a corresponding uplink frame is to start based at least in part on the TA value. For example, the UE 120 may determine the amount of time 610 according to the formula defined by the 3GPP Specifications (for example, 3GPP Technical Specification 38.211, Version 16.8.0): T_{TA}=(N_{TA}+N_{TA offset}) T_{c}, where N_{TA} is the TA value, N_{TA offset} is a TA offset value, and T_{c} is a timing constant. T_{c} may be based at least in part on a maximum subcarrier spacing and fast-Fourier transform (FFT) size of the wireless network. In some cases, T_{c} may have a value of 0.509 nanoseconds, among other examples. The TA offset value may be based at least in part on a frequency band or topology (for example, frequency division duplexing (FDD) or time division duplexing (TDD)) that is being used for communications between the UE 120 and the base station. The TA offset value may be defined, or otherwise fixed, by the 3GPP Specifications. In some examples, the TA offset value may account for an amount of time the base station takes to switch between receiving communications and transmitting communications. By starting the uplink frame an amount of time 610 before the corresponding downlink frame, the base station and the UE 120 may synchronize symbols, thereby reducing inter-symbol interference that may result from the uplink frames and downlink frames not aligning in the time domain at the base station.

In some examples, a timing advance configuration may be associated with a TA group (TAG). A TAG consists of one or more cells with the same uplink TA and same downlink timing reference cell. For a given TAG, the UE may use one downlink carrier as a timing reference at a given time. The UE may use a downlink carrier in a TAG as a timing reference for that TAG. In some examples, a TA value may be an absolute or non-accumulative TA value. For example, the base station may indicate a TA command (for example, for a TAG), and the TA value calculated by the UE using the TA command, in a similar manner as described above. In some other cases, a TA value may be an accumulative value. For example, the base station may indicate a TA command (for example, for a TAG), and the TA value calculated by the UE may be relative to a previous TA value calculated by the UE (for example, as defined or otherwise fixed by the 3GPP, such as in Technical Specification 38.213, Version 16.5.0, Section 4.2).

As described above, a TA configuration or TA command may be per-CC (for example, a single TA configuration or a single TA command may be indicated by the network for a given CC). However, in some cases, multiple cells may be activated for the UE for a given CC. For example, in multi-TRP scenarios, at least one additional cell (for example, in addition to a serving cell) may be activated for the UE for a CC. For example, the UE may be configured with a set of PCIs for a CC, and two or more PCIs, from the set of PCIs, may be activated for the UE at a given time. In some cases, the two or more cells (for example, the two or more PCIs) may be associated with different transmission timings. For example, the two or more cells may be associated with TRPs that are physically located in different locations (for example, resulting in the amounts of time for an uplink transmission from the UE to reach the different TRPs being different) or may be associated with different uplink propagation delays, among other examples. However, because the CC may be associated with a single TA configuration or TA command from the network, the same uplink transmission timing may be used by the UE to transmit uplink communications to the two or more cells (for example, to the two or more TRPs). As a result, because the two or more cells (for example, the two or more TRPs) may be associated with different timing alignments between uplink frames and downlink frames, and because the UE applies the same uplink transmission timing for the two or more cells, communication performance associated with the two or more cells may be degraded. For example, communications with the two or more cells may experience inter-symbol interference that may result from the uplink frames and downlink frames not aligning in the time domain at the two or more cells (for example, at the two or more TRPs).

Various aspects relate generally to enabling multiple timing advance (TA) configurations for scenarios involving multiple transmission reception points (TRPs). Some aspects more specifically relate to a user equipment (UE) receiving (for example, from a network, a base station, a TRP, or a radio unit (RU)) a first timing advance configuration associated with a serving cell and a second one or more timing advance configurations respectively associated with two or more other cells, where the serving cell and the two or more other cells are associated with the same component carrier (CC). In some examples, the UE may receive configuration information (for example, from the network, a base station, a TRP, a central unit (CU), or a distributed unit (DU)) configuring the UE, for the same CC, with the first timing advance configuration associated with the serving cell and the second one or more timing advance configurations associated with the two or more other cells. In some aspects, the serving cell is associated with a first TRP and the two or more other cells are respectively associated with two or more other TRPs. In some examples, the UE may be configured, for the CC, with a physical cell identifier (PCI) for the serving cell and two or more PCIs for the two or more other cells, respectively (for example, where the two or more other cells are non-serving cells). In some aspects, the two or more timing advance configurations may include a separate, respective timing advance configuration for each cell of the two or more other cells. In some other aspects, the two or more timing advance configurations may include a single timing advance configuration that is associated with each cell included in the two or more other cells.

In some additional aspects, the UE may be scheduled to transmit a first uplink communication and to transmit a second uplink communication. The first uplink communication and the second uplink communication may at least partially overlap in the time domain (for example, due to the different timing advance configurations). In some aspects, if the first uplink communication and the second uplink communication are associated with the same TA group (TAG) identifier (for example, indicating that the first uplink communication and the second uplink communication are to be transmitted to the same cell or the same TRP), then the UE may reduce a transmission time of one of the first uplink communication or the second uplink communication so as to mitigate or eliminate the at least partial overlap in the time domain. In some aspects, the uplink transmission, from the first uplink transmission and the second uplink transmission, that is reduced (for example, that is not transmitted during time domain resources in which the first uplink communication and the second uplink communication overlapped as scheduled) may be based at least in part on which uplink communication was scheduled to be transmitted earlier in the time domain, or priorities of the first uplink communication and the second uplink communication, among other examples.

In some other aspects, if the first uplink communication and the second uplink communication are associated with different TAG identifiers (for example, indicating that the first uplink communication and the second uplink communication are to be transmitted to the different cells or different TRPs), then the UE may transmit the first uplink communication and the second uplink communication as scheduled (for example, without modifying a transmission time of either uplink communication). In other words, the UE may simultaneously transmit the first uplink communication and the second uplink communication during the time domain resources in which the first uplink communication and the second uplink communication overlap. In some aspects, the UE may simultaneously transmit the first uplink communication and the second uplink communication based at least in part on the UE being capable of simultaneous uplink transmissions, or the first uplink communication and the second uplink communication being compatible for simultaneous transmissions (for example, based on channels to be used to transmit the first uplink communication and the second uplink communication), among other examples. In some other aspects, where the first uplink communication and the second uplink communication are associated with different TAG identifier, the UE may reduce a transmission time of one of the first uplink communication or the second uplink communication so as to mitigate or eliminate the at least partial overlap in the time domain (for example, based at least in part on the first uplink communication and the second uplink communication not being compatible for simultaneous transmissions, or the UE not supporting a capability associated with simultaneous transmissions). In such examples, the UE may the uplink transmission, from the first uplink transmission and the second uplink transmission, that is reduced may be based at least in part on which uplink communication was scheduled to be transmitted earlier in the time domain, priorities of the first uplink communication and the second uplink communication, or the TAG identifiers of the first uplink communication and the second uplink communication, among other examples.

Particular aspects of the subject matter described in this disclosure can be implemented to realize one or more of the following potential advantages. In some examples, the described techniques can be used to enable different TA values for different cells that are associated with the same CC (for example, in multiple TRP (multi-TRP) scenarios). For example, the UE may be enabled to apply different TA values for uplink transmissions to different cells associated with the same CC, thereby enabling the UE and the cells (for example, the TRPs) to synchronize symbols (for example, to synchronize uplink and downlink frames). Enabling the UE to synchronize symbols for multiple cells associated with the same CC may reduce inter-symbol interference that would have otherwise resulted from the uplink frames and downlink frames not aligning in the time domain at the different cells. Additionally, the UE may be enabled to handle overlapping uplink transmissions that may result from the UE applying different TA values in a multi-TRP scenario. For example, the UE may be enabled to identify whether to transmit two scheduled uplink communications that at least partially overlap in the time domain (for example, to simultaneously transmit the two scheduled uplink communications) or to reduce a time domain resource allocation for one of the two scheduled uplink communications so that the two uplink communications do not overlap. This may improve a performance or resource utilization of the UE (for example, by enabling the UE to simultaneously transmit two scheduled uplink transmissions in appropriate scenarios) and may reduce a likelihood of the two scheduled uplink transmissions causing interference (for example, in scenarios where simultaneous transmissions of the two scheduled uplink transmissions is not appropriate).

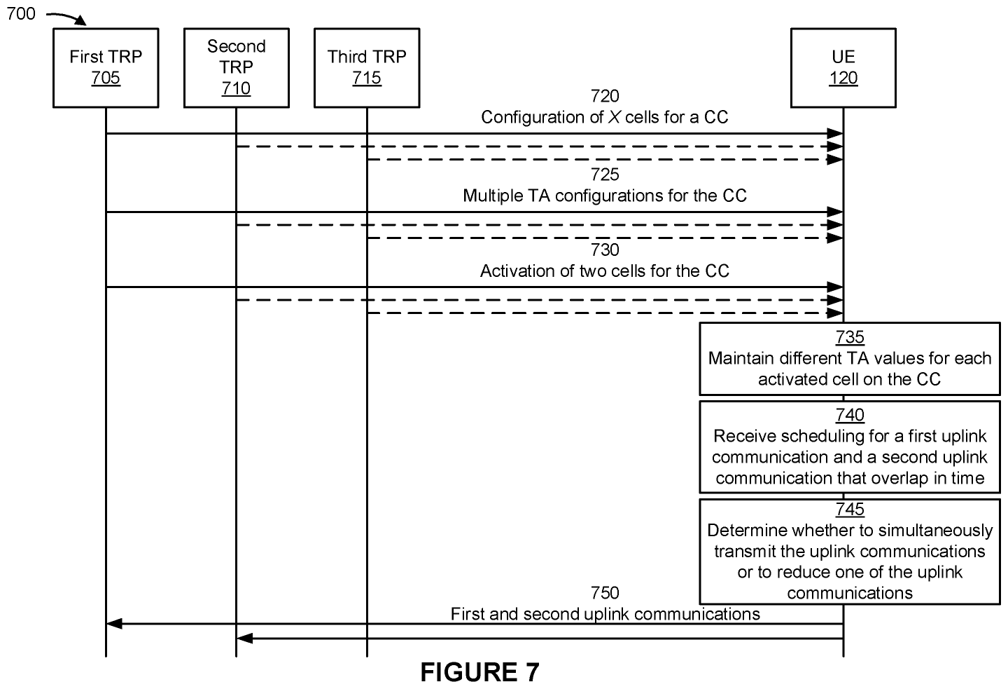

FIG. 7 is a diagram illustrating an example associated with multiple TA configurations for multi-TRP scenarios 700, in accordance with the present disclosure. As shown in FIG. 7, a UE 120 may communicate with a first TRP 705, a second TRP 710, and a third TRP 715. The TRPs (for example, the first TRP 705, the second TRP 710, and the third TRP 715) may be base stations or may include one or more components associated with a base station, such as an RU, a DU, or a CU, among other examples. While three TRPs are depicted in FIG. 7, the UE 120 may communicate with more, or less, TRPs in a similar manner as described herein. In some aspects, the UE 120, the first TRP 705, the second TRP 710, and the third TRP 715 may be part of a wireless network, such as the wireless network 100. The UE 120 may have established a wireless connection with the first TRP 705, the second TRP 710, and the third TRP 715 prior to operations shown in FIG. 7.

In a first operation 720, the UE 120 may receive configuration information. For example, the UE 120 may receive the configuration information from the first TRP 705, the second TRP 710, or the third TRP 715. In some other aspects, the UE 120 may receive the configuration information from another network entity, such as a base station, a DU, or a CU, among other examples. In some aspects, the UE 120 may receive the configuration information via one or more of RRC signaling, one or more MAC control elements (MAC-CEs), or DCI, among other examples. In some aspects, the configuration information may include an indication of one or more configuration parameters (for example, already known to the UE 120 or previously indicated to the UE 120) for selection by the UE 120, or explicit configuration information for the UE 120 to use to configure the UE 120, among other examples.

In some aspects, the configuration information may be associated with a serving cell and two or more other cells (for example, candidate non-serving cells). For example, a “serving cell” may carry control information (for example, downlink control information or scheduling information) for scheduling data communications. A “non-serving cell” may be associated with providing additional data capacity for the UE 120. For example, a serving cell may be a primary carrier or primary cell (PCell) and a non-serving cell may be a secondary carrier or a secondary cell (SCell). For example, the first TRP 705 may be associated with a serving cell or a PCell for a CC. The second TRP 710 and the third TRP 715 may be associated with non-serving cells or SCells for the CC. The serving cell may be associated with a first PCI and the two or more other cells may be associated with two or more other PCIs. In some aspects, each of the first TRP 705, the second TRP 710, and the third TRP 715 may be associated with different PCIs. For example, the first TRP 705 may be associated with a first PCI, the second TRP 710 may be associated with a second PCI, and the third TRP 715 may be associated with a third PCI. In some aspects, the UE 120 may receive a downlink or uplink (e.g., PDSCH/PDCCH/PUSCH/PUCCH) configuration for each configured cell. For example, the UE 120 may receive a first downlink or uplink (e.g., PDSCH/PDCCH/PUSCH/PUCCH) associated with the first TRP 705, a second downlink or uplink (e.g., PDSCH/PDCCH/PUSCH/PUCCH) associated with the second TRP 710, and a third downlink or uplink (e.g., PDSCH/PDCCH/PUSCH/PUCCH) associated with the third TRP 715. In some aspects, the configuration information may indicate one or more TCI states associated with each PCI. For example, the UE 120 may be configured with one or more TCI states for each configured PCI (for example, a first one or more TCI states associated with a first PCI, a second one or more TCI states associated with a second PCI, a third one or more TCI states associated with a third PCI, and so on).

In other words, the UE 120 may be configured with a PCI for a serving cell for a CC (for example, the first PCI associated with the first TRP 705) and X PCIs for candidate non-serving cells for the CC (for example, the second PCI associated with the second TRP 710 and the third PCI associated with the third TRP 715). While the value of X is two in the examples described herein, other values of X are also contemplated, such as 1, 3, 4, or 7, among other examples. In some aspects, the value of X may be based at least in part on a capability of the UE 120. For example, the UE 120 may transmit a capability report indicating one or more capabilities supported by the UE 120. For example, the UE 120 may transmit an indication of a quantity of candidate non-serving cells that can be configured for a single CC (for example, a supported value of X).

In some aspects, the configuration information may also include TA configurations for the configured cells. For example, in a second operation 725, the UE 120 may receive a first timing advance configuration associated with the serving cell (for example, associated with the first TRP 705) and a second one or more timing advance configurations associated with the two or more other cells (for example, associated with the second TRP 710 and the third TRP 715). In other words, when a value of X (for example, when a value of the quantity of PCIs configured for a given CC in addition to the PCI for the serving cell) is greater than 1 (for example, is two or more), the UE 120 may be configured with one or more additional TA configurations to be associated with the X PCIs. In some aspects, the UE 120 may receive the TA configurations in the same configuration as the configurations of the serving cell and two or more other cells (for example, the information transmitted in the first operation 720 and the second operation 725 may be included in the same configuration). Alternatively, the UE 120 may receive the TA configurations in a different configuration than the configurations of the serving cell and two or more other cells (for example, the information transmitted in the first operation 720 and the second operation 725 may be included in different configurations or different messages). A timing advance configuration may indicate a TAG identifier associated with the timing advance configuration, an N_{TA} value, or an N_{TA} offset value, among other examples, where the N_{TA} value may be updated by timing advance commands (for example, received by the UE 120 from a TRP, base station, or network entity), and the N_{TA} offset value is configured as a fixed value.

In some aspects, the second one or more timing advance configurations may include separate timing advance configurations for each cell included in the two or more other cells. In other words, the UE 120 may receive a second timing advance configuration associated with the second TRP 710 and a third timing advance configuration associated with the third TRP 715. For example, the UE 120 may receive X additional timing advance configurations (for example, in addition to a timing advance configuration for the serving cell for a CC) for the CC. In other words, the UE 120 may receive X additional TAG identifiers, X additional N_{TA} values, or X additional N_{TA offset} values, among other examples, for the CC.

In some other aspects, the second one or more timing advance configurations may include a single timing advance configuration that is associated with each cell included in the two or more other cells. For example, the UE 120 may receive an indication of a single timing advance configuration (for example, in addition to a timing advance configuration for the serving cell for a CC) for the CC that is to be applied to all other cells other than the serving cell. For example, the single timing advance configuration may be associated with the second TRP 710 and the third TRP 715. In other words, the UE 120 may receive one additional TAG identifier, one additional N_{TA} value, or one additional N_{TA offset} value, among other examples, for the CC.

The UE 120 may configure itself based at least in part on the configuration information. In some aspects, the UE 120 may be configured to perform one or more operations described herein based at least in part on the configuration information.

In a third operation 730, the UE 120 may receive an activation of a non-serving cell to a cell from the two or more other cells. For example, the second TRP 710 may be activated for the CC (for example, in addition to the serving cell associated with the first TRP 705). The activation of the non-serving cell may be based at least in part on an activation of a TCI state associated with the non-serving cell. For example, the UE 120 may receive a message indicating that a TCI state associated with a second PCI (for example, associated with the second TRP 710) is activated for the CC. Based at least in part on receiving the activation of the TCI state, the UE 120 may determine that the second PCI (for example, associated with the second TRP 710) is activated for the CC.

In a fourth operation 735, the UE 120 may maintain different TA values for each activated cell on the CC. For example, the first PCI associated with the first TRP 705 and the second PCI associated with the second TRP 710 may be activated for the CC. Therefore, during a given slot, the UE 120 may maintain a first TA value for the first PCI (for example, based at least in part on the first timing advance configuration associated with the first PCI) and may maintain a second TA value for the second PCI (for example, based at least in part on a second timing advance configuration associated with the second PCI). The TA value applied by the UE 120 may be based at least in part on scheduling received by the UE 120. For example, if the UE 120 receives scheduling information associated with the first PCI or the first TRP 705, then the UE 120 may apply the first TA value when transmitting an uplink communication. If the UE 120 receives scheduling information associated with the second PCI or the second TRP 710, then the UE 120 may apply the second TA value when transmitting an uplink communication.

In some aspects, the second TA value (for example, associated with the non-serving cell for the CC or the second TRP 710) may be reset when a new PCI is activated or may be based at least in part on a TA value of a previously active non-serving cell for the CC. For example, the UE 120 may transmit, to the non-serving cell (for example, to the second TRP 710), an uplink communication using a timing that is based at least in part on a timing advance command associated with the non-serving cell and a timing advance value (for example, an N_{TA} value) that is associated with the cell, where the timing advance value is indicated by the timing advance configuration associated with the non-serving cell). In some other aspects, the UE 120 may transmit, to the non-serving cell (for example, to the second TRP 710), an uplink communication using timing that is based at least in part on a timing advance command associated with the non-serving cell and a timing advance value (for example, an N_{TA} value) that is associated with a previously active non-serving cell associated with the CC. In other words, the UE 120 may reset the N_{TA} value when a non-serving cell PCI is updated or activated for the CC. Alternatively, the UE 120 may maintain or keep the N_{TA} value from a previously active non-serving cell when a non-serving cell PCI is updated or activated for the CC.

As described above, a timing advance configuration may be associated with a TAG configuration. For example, the second one or more timing advance configurations may include one or more TAG configurations. In some aspects, the UE 120 may receive an activation of a TAG configuration from the one or more TAG configurations (for example, from a serving cell, the first TRP 705, the second TRP 710, the third TRP 715, or another network entity). In other words, a TAG configuration for a non-serving cell of the CC may be activated. In some aspects, the UE 120 may receive a MAC-CE message activating the TAG configuration for a PCI of at least one of the two or more other cells (for example, of the second TRP 710 or the third TRP 715). Additionally or alternatively, the UE 120 may receive downlink control information activating the TAG configuration for a PCI of at least one of the two or more other cells (for example, of the second TRP 710 or the third TRP 715).

Additionally or alternatively, the UE 120 may receive a TCI state activation for a TCI state associated with a PCI of at least one of the two or more other cells (for example, of the second TRP 710 or the third TRP 715). The TCI state activation for the TCI state associated with the PCI of the non-serving cell may indicate that the TAG configuration associated with the cell is activated. The TCI state activation may be included in a MAC-CE message or a DCI message, among other examples. For example, when the UE 120 is activated with multiple TCI states associated with SSBs having a PCI for a TRP or CORESET pool index, then the TAG associated with the PCI is also activated.

In a fifth operation 740, the UE 120 may receive scheduling information for a first uplink communication and a second uplink communication that at least partially overlap in the time domain based at least in part on a timing advance value applied by the UE 120. For example, the UE 120 may receive first downlink control information scheduling a first uplink communication to use a first set of time domain resources. The UE 120 may receive second downlink control information scheduling a second uplink communication to use a second set of time domain resources. A timing used by the UE 120 may result in the first uplink communication and the second uplink communication at least partially overlapping in the time domain. For example, the first set of time domain resources may be associated with a first one or more slots or OFDM symbols, and the second set of time domain resources may be associated with a second one or more slots or OFDM symbols. Based at least in part on a timing advance value associated with the second uplink communication, the UE 120 may adjust a timing of the second one or more slots or OFDM symbols (for example, a second one or more uplink frames) such that the second one or more slots or OFDM symbols at least partially overlap in the time domain with the first one or more slots or OFDM symbols. For example, a timing advance value applied by the UE 120 for the second set of time domain resources may be greater than a timing advance value applied by the UE 120 for the first set of time domain resources, thereby resulting in an overlap in an at least partial overlap time domain between the first set of time domain resources and the second set of time domain resources.

In some aspects, the UE 120 may receive the scheduling information for the first uplink communication and the second uplink communication from the same TRP (for example, from the first TRP 705). In some other aspects, the UE 120 may receive the scheduling information for the first uplink communication and the second uplink communication from different TRPs (for example, from the first TRP 705 and the second TRP 710). In some other aspects, the UE 120 may receive the scheduling information for the first uplink communication and the second uplink communication from another network entity, such as a base station, a CU, or a DU, among other examples.

In a sixth operation 745, the UE 120 may determine whether to simultaneously transmit the first uplink communication and the second uplink communication or to reduce the time domain resource allocations of one of the uplink communications. As used herein, “simultaneous transmissions” may refer to the UE 120 transmitting two or more uplink communications where the two or more uplink communications at least partially overlap in the time domain. As used herein, a “reduced uplink communication” may refer to an uplink communication that is transmitted by the UE 120 using fewer time domain resources that the time domain resources allocated for the uplink communication. For example, in some cases, the UE 120 may reduce the time domain resources of an uplink communication such that the reduced time domain resources do not overlap in the time domain with the time domain resources of another uplink communication. For example, the UE 120 may delay a start time of a transmission of an uplink communication or may cease the transmission of an uplink communication prior to a scheduled end of the uplink communication.

The UE 120 may determine whether to simultaneously transmit the first uplink communication and the second uplink communication or to reduce a time domain resource allocation of one of the uplink communications based at least in part on a capability of the UE 120. For example, if the UE 120 is not capable of performing simultaneous transmissions, then the UE 120 may determine to reduce one of the uplink communications time domain resource allocations. Additionally or alternatively, the UE 120 may determine whether to simultaneously transmit the first uplink communication and the second uplink communication or to reduce one of the uplink communications time domain resource allocations based at least in part on TAG identifiers associated with the uplink communications. Additionally or alternatively, the UE 120 may determine whether to simultaneously transmit the first uplink communication and the second uplink communication or to reduce one of the uplink communications time domain resource allocations based at least in part on channels used to transmit the first uplink communication and the second uplink communication. For example, one or more combinations of channels or transmission types may be incompatible for simultaneous transmission (for example, the one or more combinations of channels or transmission types may be defined or otherwise fixed by a wireless communication standard, such as the 3GPP). Alternatively, one or more combinations of channels or transmission types that are compatible for simultaneous transmission may be defined (for example, by a wireless communication standard, such as the 3GPP).

For example, in a seventh operation 750, the UE 120 may transmit the first uplink communication or the second uplink communication. For example, the UE 120 may transmit the first uplink communication in accordance with the first timing advance configuration (for example, using a timing that is based at least in part on the first timing advance configuration). Additionally or alternatively, the UE 120 may transmit the second uplink communication in accordance with the second timing advance configuration (for example, using a timing that is based at least in part on the second timing advance configuration). For example, the UE 120 may transmit the first uplink communication using the first set of time domain resources (for example, as scheduled). The UE 120 may transmit the second uplink communication using a reduced set of time domain resources from the second set of time domain resources (for example, reduced from the allocated time domain resource allocation for the second uplink communication). For example, the reduced set of time domain resources may be reduced so as to not overlap with the first set of time domain resources. The UE 120 may reduce the second set of time domain resources or the first set of time domain resources based at least in part on the first uplink communication and the second uplink communication being associated with the same TAG identifier. In other words, if two uplink communications at least partially overlap in time due to an applied timing advance value and the two uplink communications are associated with the same TAG identifier, then the UE 120 may reduce a time domain resource allocation for one of the uplink communications so as to mitigate or eliminate the overlap in time. For example, the two uplink communications being associated with the same TAG identifier may indicate that the two uplink communications are associated with the same TRP. Therefore, to reduce potential interference caused by the two uplink communications arriving at the same TRP in overlapping time domain resources, the UE 120 may reduce a time domain resource allocation for one of the uplink communications.

Additionally or alternatively, the UE 120 may reduce the second set of time domain resources or the first set of time domain resources based at least in part on the first uplink communication and the second uplink communication being incompatible for simultaneous transmissions. For example, one or more combinations of channels or transmission types that are compatible for simultaneous transmission may be defined. The first uplink communication and the second uplink communication may be associated with a combination of channels or transmission types that are not compatible for simultaneous transmission. For example, combinations of channels or transmission types that are compatible for simultaneous transmission may include physical uplink shared channel (PUSCH)+PUSCH, physical uplink control channel (PUCCH)+PUCCH, or PUSCH+PUCCH, among other examples. Combinations of channels or transmission types that are not compatible for simultaneous transmission may include PUCCH+sounding reference signal (SRS), among other examples.

Additionally or alternatively, the UE 120 may reduce the second set of time domain resources or the first set of time domain resources based at least in part on the UE 120 not supporting a capability for simultaneous transmissions. The UE 120 may identify which uplink transmission to reduce if the UE 120 determines to reduce the second set of time domain resources or the first set of time domain resources, as described above. For example, the reduced uplink communication may be identified, from the first uplink communication or the second uplink communication, based at least in part on a first starting time of the first set of time domain resources and a second starting time of the second set of time domain resources. In other words, the uplink communication that starts earlier in time or later in time may be reduced by the UE 120 (for example, the uplink communication associated with time domain resources that start at a later time).

Additionally or alternatively, the reduced uplink communication may be identified, from the first uplink communication or the second uplink communication, based at least in part on a first priority associated with the first uplink communication and a second priority associated with the second uplink communication. For example, the uplink communication that is associated with a lower priority level may be reduced. The first priority and the second priority may be based at least in part on a PHY layer priority, an uplink channel type (for example, the PUSCH may be associated with higher priority than an SRS channel), or a scheduling signaling type (for example, communications scheduled via DCI may be associated with a higher priority than communications scheduled via configured grants (CGs) or other semi-persistent or periodic scheduling mechanisms).

Additionally or alternatively, the reduced uplink communication may be identified, from the first uplink communication or the second uplink communication, based at least in part on the first TAG identifier (for example, associated with the first uplink communication) and the second TAG identifier (for example, associated with the second uplink communication). For example, a default rule may be defined or configured indicating a TAG identifier that is to be associated with reduced uplink communications. For example, the uplink communication associated with a predetermined TAG identifier may be the reduced uplink communication.

In some other aspects, the UE 120 may simultaneously transmit the first uplink communication and the second uplink communication in the seventh operation 750. For example, the UE 120 may transmit the first uplink communication using the first set of time domain resources (for example, as scheduled in the fifth operation 740). The UE 120 may transmit the second uplink communication using the second set of time domain resources (for example, as scheduled in the fifth operation 740). The UE 120 may simultaneously transmit the first uplink communication and the second uplink communication based at least in part on the first uplink communication being associated with a first TAG identifier and the second uplink communication being associated with a second TAG identifier (for example, based at least in part on the first uplink communication and the second uplink communication being associated with different TAG identifiers), the UE supporting a capability for simultaneous transmissions, or the first uplink communication and the second uplink communication being compatible for simultaneous transmission (for example, being associated with a combination of channels or transmission types that are compatible for simultaneous transmission, as defined or otherwise fixed by a wireless communication standard, such as the 3GPP), among other examples.

Particular aspects of the subject matter described in this disclosure can be implemented to realize one or more of the following potential advantages. In some examples, the described techniques can be used to enable different TA values for different cells that are associated with the same CC (for example, in multi-TRP scenarios). For example, the UE 120 may be enabled to apply different TA values for uplink transmissions to different cells associated with the same CC, thereby enabling the UE 120 and the cells (for example, the TRPs) to synchronize symbols (for example, to synchronize uplink and downlink frames). Enabling the UE 120 to synchronize symbols for multiple cells associated with the same CC may reduce inter-symbol interference that would have otherwise resulted from the uplink frames and downlink frames not aligning in the time domain at the different cells. Additionally, the UE 120 may be enabled to handle overlapping uplink transmissions that may result from the UE 120 applying different TA values in a multi-TRP scenario. For example, the UE 120 may be enabled to identify whether to transmit two scheduled uplink communications that at least partially overlap in the time domain (for example, to simultaneously transmit the two scheduled uplink communications) or to reduce a time domain resource allocation for one of the two scheduled uplink communications. This may improve a performance or resource utilization of the UE 120 (for example, by enabling the UE 120 to simultaneously transmit two scheduled uplink transmissions in appropriate scenarios) and may reduce a likelihood of the two scheduled uplink transmissions causing interference (for example, in scenarios where simultaneous transmission of the two scheduled uplink transmissions is not appropriate).

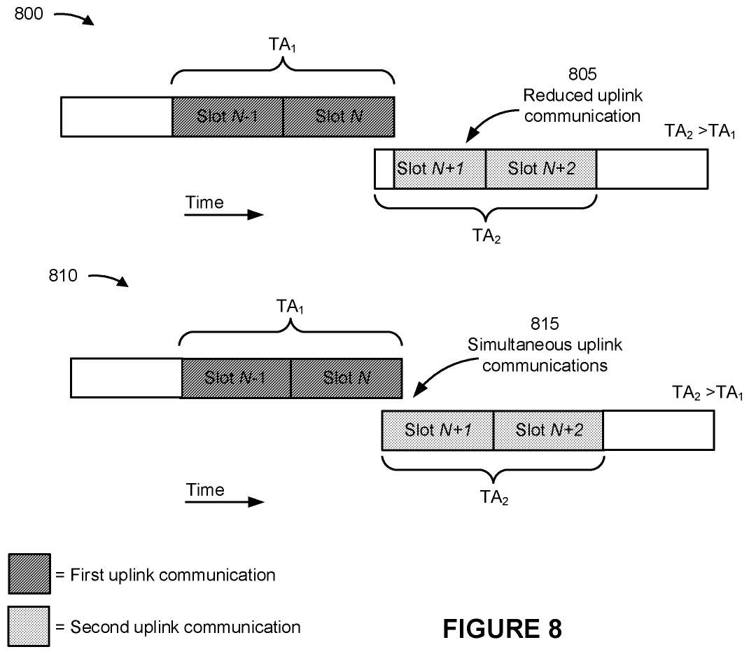

FIG. 8 is a diagram illustrating examples associated with overlapping uplink communications in multiple TA, multi-TRP scenarios, in accordance with the present disclosure. For example, the UE 120 may be configured with multiple TA configurations for the same CC in a similar manner as described elsewhere herein, such as in connection with FIG. 7. The UE 120 may be scheduled with a first uplink communication and a second uplink communication. The first uplink communication and the second uplink communication may be associated with the same CC (for example, may be transmitted via the same CC). The first uplink communication and the second uplink communication may be adjacent communications (for example, may be scheduled in adjacent slots). For example, the first uplink communication may be scheduled to be transmitted in a slot N−1 and a slot N, and the second uplink communication may be scheduled to be transmitted in a slot N+1 and a slot N+2. Based at least in part on the scheduling (for example, based at least in part on a PCI of a TAG associated with the first uplink communication), the UE 120 may identify a timing advance value to apply for the first uplink communication (for example, TA₁). Similarly, the UE 120 may identify (for example, based at least in part on a PCI of a TAG associated with the second uplink communication) a timing advance value to apply for the second uplink communication (for example, TA₂). As shown in FIG. 8, TA₂ may be greater than TA₁, resulting in an overlap of the slot N and the slot N+1 (for example, as shown in FIG. 8).

In a first set of overlapping communications 800, the UE 120 may transmit a reduced uplink communication 805. For example, as shown in FIG. 8, the reduced uplink communication 805 may be the second uplink communication. For example, the UE 120 may delay a start of (for example, partially cancel) a transmission of the second uplink communication in the slot N+1 (for example, until an end of the slot N). In other aspects, the reduced uplink communication 805 may be the first uplink communication. For example, the UE 120 may end a transmission of the first uplink communication before the end of the slot N (for example, at a start of the slot N+1). The UE 120 may transmit the reduced uplink communication 805 and may identify which communication is the reduced uplink communication 805 (for example, from the first uplink communication and the second uplink communication) in a similar manner as described above in connection with FIG. 7 (for example, based at least in part on the first uplink communication and the second uplink communication being associated with the same TAG identifier, among other examples).

In a second set of overlapping communications 810, the UE 120 may transmit simultaneous uplink communications 815. For example, as shown in FIG. 8, the UE 120 may not modify a time domain resource allocation of the first uplink communication or the second uplink communication. During the time in which the first uplink communication and the second uplink communication overlap, the UE 120 may transmit both the first uplink communication and the second uplink communication at the same time. This may improve a resource utilization of the UE 120 by enabling the UE 120 to transmit both the first uplink communication and the second uplink communication using at least partially the same time domain resources. The UE 120 may transmit the simultaneous uplink communications 815 in a similar manner as described above in connection with FIG. 7 (for example, based at least in part on the first uplink communication and the second uplink communication being associated with different TAG identifiers or based at least in part on the UE 120 supporting simultaneous transmissions, among other examples).

FIG. 9 is a flowchart illustrating an example process 900 performed, for example, by a UE associated with multiple timing advance configurations for multi-TRP scenarios, in accordance with the present disclosure. Example process 900 is an example where the UE (for example, UE 120) performs operations associated with multiple timing advance configurations for multi-TRP scenarios.

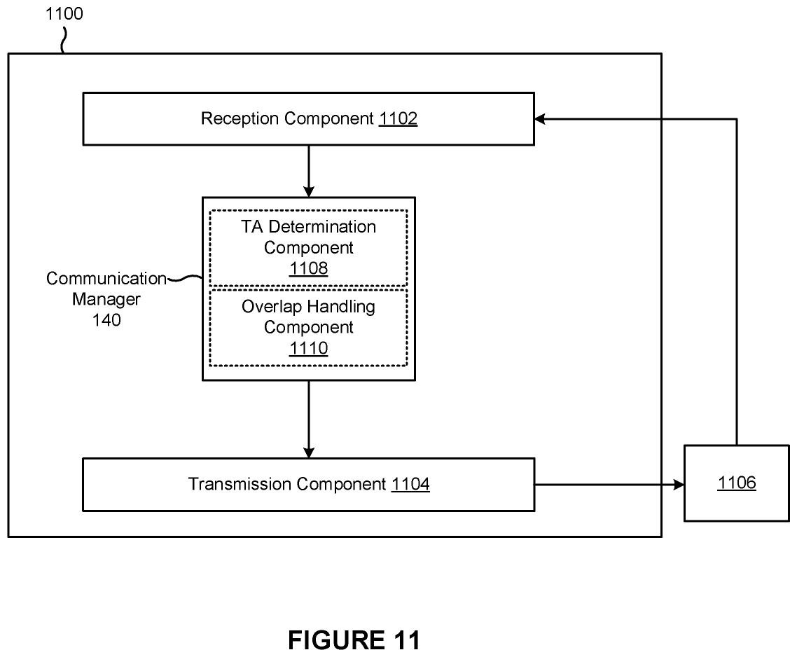

As shown in FIG. 9, in some aspects, process 900 may include receiving configuration information for a serving cell associated with a first TRP and for two or more other cells associated with two or more other TRPs, the serving cell and the two or more other cells being associated with a same component carrier (block 910). For example, the UE (such as by using communication manager 140 or reception component 1102, depicted in FIG. 11) may receive configuration information for a serving cell associated with a first TRP and for two or more other cells associated with two or more other TRPs, the serving cell and the two or more other cells being associated with a same component carrier, as described above.

As further shown in FIG. 9, in some aspects, process 900 may include receiving a first timing advance configuration associated with the serving cell and a second one or more timing advance configurations associated with the two or more other cells (block 920). For example, the UE (such as by using communication manager 140 or reception component 1102, depicted in FIG. 11) may receive a first timing advance configuration associated with the serving cell and a second one or more timing advance configurations associated with the two or more other cells, as described above.

As further shown in FIG. 9, in some aspects, process 900 may optionally include transmitting an uplink communication in accordance with the first timing advance configuration or the second one or more timing advance configurations (block 930). For example, the UE (such as by using communication manager 140 or transmission component 1104, depicted in FIG. 11) may transmit an uplink communication in accordance with the first timing advance configuration or the second one or more timing advance configurations, as described above.

Process 900 may include additional aspects, such as any single aspect or any combination of aspects described below or in connection with one or more other processes described elsewhere herein.

In a first additional aspect, the serving cell is associated with a first PCI and the two or more other cells are associated with two or more other PCIs.

In a second additional aspect, alone or in combination with the first aspect, receiving the second one or more timing advance configurations includes receiving a separate respective timing advance configuration for each cell included in the two or more other cells.

In a third additional aspect, alone or in combination with one or more of the first and second aspects, receiving the second one or more timing advance configurations includes receiving a single timing advance configuration that is associated with each cell included in the two or more other cells.

In a fourth additional aspect, alone or in combination with one or more of the first through third aspects, process 900 includes receiving an activation message that activates a non-serving cell, where the non-serving cell is a cell from the two or more other cells, receiving, from the cell, a timing advance command, and transmitting, to the cell, an uplink communication using a timing that is based at least in part on the timing advance command and a timing advance value that is associated with the cell, wherein the timing advance value is indicated by the second one or more timing advance configurations.

In a fifth additional aspect, alone or in combination with one or more of the first through fourth aspects, process 900 includes receiving an activation message that activates a non-serving cell, where the non-serving cell is a cell from the two or more other cells, receiving, from the cell, a timing advance command, and transmitting, to the cell, an uplink communication using a timing that is based at least in part on the timing advance command and a timing advance value that is associated with a previously active non-serving cell from the two or more other cells.

In a sixth additional aspect, alone or in combination with one or more of the first through fifth aspects, the second one or more timing advance configurations include one or more TAG configurations, and process 900 includes receiving an activation message that activates a TAG configuration from the one or more TAG configurations.

In a seventh additional aspect, alone or in combination with one or more of the first through sixth aspects, receiving the activation message that activates the TAG configuration includes receiving a MAC-CE message activating the TAG configuration for a PCI of at least one of the two or more other cells.

In an eighth additional aspect, alone or in combination with one or more of the first through seventh aspects, receiving the activation message that activates the TAG configuration includes receiving downlink control information activating the TAG configuration for a PCI of at least one of the two or more other cells.

In a ninth additional aspect, alone or in combination with one or more of the first through eighth aspects, the TAG configuration is associated with a cell of the two or more other cells, the cell is associated with a PCI, and receiving the activation message that activates the TAG configuration includes receiving a TCI state activation for a TCI state associated with the PCI of the cell, wherein the TCI state activation for the TCI state associated with the PCI of the cell indicates that the TAG configuration associated with the cell is activated.

In a tenth additional aspect, alone or in combination with one or more of the first through ninth aspects, the TCI state activation is included in a MAC-CE message or a downlink control information message.

In an eleventh additional aspect, alone or in combination with one or more of the first through tenth aspects, the first timing advance configuration is associated with a first TAG identifier, a non-serving cell, from the two or more other cells, is activated and is associated with a timing advance configuration, from the second one or more timing advance configurations, that is associated with a second TAG identifier, and process 900 includes receiving first downlink control information scheduling a first uplink communication to use a first set of time domain resources, and receiving second downlink control information scheduling a second uplink communication to use a second set of time domain resources, wherein the first set of time domain resources and the second set of time domain resources at least partially overlap in a time domain based on an applied timing advance value.

In a twelfth additional aspect, alone or in combination with one or more of the first through eleventh aspects, the second set of time domain resources start at a later time than the first set of time domain resources, and process 900 includes transmitting the first uplink communication using the first set of time domain resources, and transmitting the second uplink communication using a reduced set of time domain resources from the second set of time domain resources, wherein the reduced set of time domain resources are reduced to not overlap with the first set of time domain resources.

In a thirteenth additional aspect, alone or in combination with one or more of the first through twelfth aspects, transmitting the second uplink communication using the reduced set of time domain resources is based at least in part on at least one of: the first TAG identifier being the same as the second TAG identifier, the first uplink communication and the second uplink communication being incompatible for simultaneous transmissions, or the UE not supporting a capability for simultaneous transmissions.

In a fourteenth additional aspect, alone or in combination with one or more of the first through thirteenth aspects, process 900 includes transmitting the first uplink communication using the first set of time domain resources, and transmitting the second uplink communication using the second set of time domain resources.

In a fifteenth additional aspect, alone or in combination with one or more of the first through fourteenth aspects, transmitting the first uplink communication using the first set of time domain resources and transmitting the second uplink communication using the second set of time domain resources is based at least in part on at least one of: the first TAG identifier being different than the second TAG identifier, or the UE supporting a capability for simultaneous transmissions.

In a sixteenth additional aspect, alone or in combination with one or more of the first through fifteenth aspects, process 900 includes transmitting a reduced uplink communication, from the first uplink communication or the second uplink communication, using a reduced set of time domain resources to cause the first set of time domain resources and the second set of time domain resources to not overlap.

In a seventeenth additional aspect, alone or in combination with one or more of the first through sixteenth aspects, the reduced uplink communication is identified, from the first uplink communication or the second uplink communication, based at least in part on a first starting time of the first set of time domain resources and a second starting time of the second set of time domain resources.

In an eighteenth additional aspect, alone or in combination with one or more of the first through seventeenth aspects, the reduced uplink communication is identified, from the first uplink communication or the second uplink communication, based at least in part on a first priority associated with the first uplink communication and a second priority associated with the second uplink communication.

In a nineteenth additional aspect, alone or in combination with one or more of the first through eighteenth aspects, the first priority and the second priority are based at least in part on at least one of a PHY layer priority, an uplink channel type, or a scheduling signaling type.

In a twentieth additional aspect, alone or in combination with one or more of the first through nineteenth aspects, the reduced uplink communication is identified, from the first uplink communication or the second uplink communication, based at least in part on the first TAG identifier and the second TAG identifier.

Although FIG. 9 shows example blocks of process 900, in some aspects, process 900 may include additional blocks, fewer blocks, different blocks, or differently arranged blocks than those depicted in FIG. 9. Additionally or alternatively, two or more of the blocks of process 900 may be performed in parallel.

FIG. 10 is a flowchart illustrating an example process 1000 performed, for example, by a network entity associated with multiple timing advance configurations for multi-TRP scenarios, in accordance with the present disclosure. Example process 1000 is an example where the network entity (for example, the base station 110, the CU 310, the DU 330, the RU 340, the first TRP 705, the second TRP 710, or the third TRP 715) performs operations associated with multiple timing advance configurations for multi-TRP scenarios.

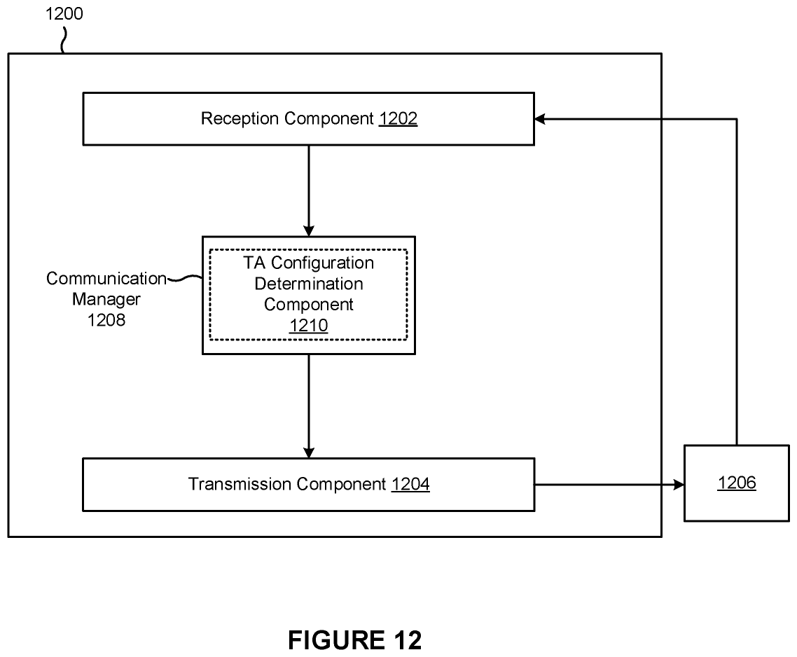

As shown in FIG. 10, in some aspects, process 1000 may include transmitting, to a UE, configuration information for a serving cell associated with a first TRP and for two or more other cells associated with two or more other TRPs, the serving cell and the two or more other cells being associated with a same component carrier (block 1010). For example, the network entity (such as by using communication manager 150 or transmission component 1204, depicted in FIG. 12) may transmit, to a UE, configuration information for a serving cell associated with a first TRP and for two or more other cells associated with two or more other TRPs, the serving cell and the two or more other cells being associated with a same component carrier, as described above.

As further shown in FIG. 10, in some aspects, process 1000 may include transmitting, to the UE, a first timing advance configuration associated with the serving cell and a second one or more timing advance configurations associated with the two or more other cells (block 1020). For example, the network entity (such as by using communication manager 150 or transmission component 1204, depicted in FIG. 12) may transmit, to the UE, a first timing advance configuration associated with the serving cell and a second one or more timing advance configurations associated with the two or more other cells, as described above.

Process 1000 may include additional aspects, such as any single aspect or any combination of aspects described below or in connection with one or more other processes described elsewhere herein.

In a first additional aspect, the serving cell is associated with a first PCI and the two or more other cells are associated with two or more other PCIs.

In a second additional aspect, alone or in combination with the first aspect, transmitting the second one or more timing advance configurations includes transmitting a separate respective timing advance configuration for each cell included in the two or more other cells.

In a third additional aspect, alone or in combination with one or more of the first and second aspects, transmitting the second one or more timing advance configurations includes transmitting a single timing advance configuration that is associated with each cell included in the two or more other cells.

In a fourth additional aspect, alone or in combination with one or more of the first through third aspects, process 1000 includes transmitting an activation message that activates a non-serving cell, where the non-serving cell is a cell from the two or more other cells, and receiving, from the UE, an uplink communication using a timing that is based at least in part on a timing advance command associated with the cell and a timing advance value that is associated with the cell, where the timing advance value is indicated by the second one or more timing advance configurations.

In a fifth additional aspect, alone or in combination with one or more of the first through fourth aspects, process 1000 includes transmitting an activation message that activates a non-serving cell, where the non-serving cell is a cell from the two or more other cells, and receiving, from the UE, an uplink communication using timing that is based at least in part on a timing advance command associated with the cell and a timing advance value that is associated with a previously active non-serving cell from the two or more other cells.

In a sixth additional aspect, alone or in combination with one or more of the first through fifth aspects, the second one or more timing advance configurations include one or more TAG configurations, and process 1000 includes transmitting, to the UE, an activation message that activates a TAG configuration from the one or more TAG configurations.

In a seventh additional aspect, alone or in combination with one or more of the first through sixth aspects, transmitting the activation message that activates the TAG configuration includes transmitting a MAC-CE message activating the TAG configuration for a PCI of at least one of the two or more other cells.

In an eighth additional aspect, alone or in combination with one or more of the first through seventh aspects, transmitting the activation message that activates of the TAG configuration includes transmitting downlink control information activating the TAG configuration for a PCI of at least one of the two or more other cells.

In a ninth additional aspect, alone or in combination with one or more of the first through eighth aspects, the TAG configuration is associated with a cell of the two or more other cells, the cell is associated with a PCI, and transmitting the activation message that activates the TAG configuration includes transmitting a TCI state activation for a TCI state associated with the PCI of the cell, where the TCI state activation for the TCI state associated with the PCI of the cell indicates that the TAG configuration associated with the cell is activated.

In a tenth additional aspect, alone or in combination with one or more of the first through ninth aspects, the TCI state activation is included in a MAC-CE message or a downlink control information message.

In an eleventh additional aspect, alone or in combination with one or more of the first through tenth aspects, the first timing advance configuration is associated with a first TAG identifier, a non-serving cell, from the two or more other cells, is activated and is associated with a timing advance configuration, from the second one or more timing advance configurations, that is associated with a second TAG identifier, and process 1000 includes transmitting first downlink control information scheduling a first uplink communication to use a first set of time domain resources, and transmitting second downlink control information scheduling a second uplink communication to use a second set of time domain resources, where the first set of time domain resources and the second set of time domain resources at least partially overlap in a time domain based on a timing advance value applied by the UE.

In a twelfth additional aspect, alone or in combination with one or more of the first through eleventh aspects, the second set of time domain resources start at a later time than the first set of time domain resources, and process 1000 includes receiving the first uplink communication using the first set of time domain resources, and receiving the second uplink communication using a reduced set of time domain resources from the second set of time domain resources, where the reduced set of time domain resources are reduced to not overlap with the first set of time domain resources.

In a thirteenth additional aspect, alone or in combination with one or more of the first through twelfth aspects, receiving the second uplink communication using the reduced set of time domain resources is based at least in part on at least one of: the first TAG identifier being the same as the second TAG identifier, the first uplink communication and the second uplink communication being incompatible for simultaneous transmissions, or the UE not supporting a capability for simultaneous transmissions.

In a fourteenth additional aspect, alone or in combination with one or more of the first through thirteenth aspects, process 1000 includes receiving the first uplink communication using the first set of time domain resources, and receiving the second uplink communication using the second set of time domain resources.

In a fifteenth additional aspect, alone or in combination with one or more of the first through fourteenth aspects, receiving the first uplink communication using the first set of time domain resources and receiving the second uplink communication using the second set of time domain resources is based at least in part on at least one of: first TAG identifier being different than the second TAG identifier, or the UE supporting a capability for simultaneous transmissions.

In a sixteenth additional aspect, alone or in combination with one or more of the first through fifteenth aspects, process 1000 includes receiving a reduced uplink communication, from the first uplink communication or the second uplink communication, using a reduced set of time domain resources to cause the first set of time domain resources and the second set of time domain resources to not overlap.

In a seventeenth additional aspect, alone or in combination with one or more of the first through sixteenth aspects, the reduced uplink communication is identified, from the first uplink communication or the second uplink communication, based at least in part on a first starting time of the first set of time domain resources and a second starting time of the second set of time domain resources.

In an eighteenth additional aspect, alone or in combination with one or more of the first through seventeenth aspects, the reduced uplink communication is identified, from the first uplink communication or the second uplink communication, based at least in part on a first priority associated with the first uplink communication and a second priority associated with the second uplink communication.

In a nineteenth additional aspect, alone or in combination with one or more of the first through eighteenth aspects, the first priority and the second priority are based at least in part on at least one of a PHY layer priority, an uplink channel type, or a scheduling signaling type.

In a twentieth additional aspect, alone or in combination with one or more of the first through nineteenth aspects, the reduced uplink communication is identified, from the first uplink communication or the second uplink communication, based at least in part on the first TAG identifier and the second TAG identifier.

Although FIG. 10 shows example blocks of process 1000, in some aspects, process 1000 may include additional blocks, fewer blocks, different blocks, or differently arranged blocks than those depicted in FIG. 10. Additionally or alternatively, two or more of the blocks of process 1000 may be performed in parallel.

FIG. 11 is a diagram of an example apparatus 1100 for wireless communication in accordance with the present disclosure. The apparatus 1100 may be a UE, or a UE may include the apparatus 1100. In some aspects, the apparatus 1100 includes a reception component 1102, a transmission component 1104, and a communication manager 140, which may be in communication with one another (for example, via one or more buses). As shown, the apparatus 1100 may communicate with another apparatus 1106 (such as a UE, a base station, or another wireless communication device) using the reception component 1102 and the transmission component 1104.

In some aspects, the apparatus 1100 may be configured to perform one or more operations described herein in connection with FIGS. 7 and 8. Additionally or alternatively, the apparatus 1100 may be configured to perform one or more processes described herein, such as process 900 of FIG. 9, or a combination thereof. In some aspects, the apparatus 1100 may include one or more components of the UE described above in connection with FIG. 2.

The reception component 1102 may receive communications, such as reference signals, control information, data communications, or a combination thereof, from the apparatus 1106. The reception component 1102 may provide received communications to one or more other components of the apparatus 1100, such as the communication manager 140. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1102 may include one or more antennas, a modem, a demodulator, a MIMO detector, a receive processor, a controller/processor, a memory, or a combination thereof, of the UE described above in connection with FIG. 2.

The transmission component 1104 may transmit communications, such as reference signals, control information, data communications, or a combination thereof, to the apparatus 1106. In some aspects, the communication manager 140 may generate communications and may transmit the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE described above in connection with FIG. 2. In some aspects, the transmission component 1104 may be co-located with the reception component 1102 in a transceiver.

The communication manager 140 may receive, or may cause the reception component 1102 to receive, configuration information for a serving cell associated with a first TRP and for two or more other cells associated with two or more other TRPs, the serving cell and the two or more other cells being associated with a same component carrier. The communication manager 140 may receive, or may cause the reception component 1102 to receive, a first timing advance configuration associated with the serving cell and a second one or more timing advance configurations associated with the two or more other cells. The communication manager 140 may transmit, or may cause the transmission component 1104 to transmit, an uplink communication in accordance with the first timing advance configuration or the second one or more timing advance configurations. In some aspects, the communication manager 140 may perform one or more operations described elsewhere herein as being performed by one or more components of the communication manager 140.

The communication manager 140 may include a controller/processor, a memory, or a combination thereof, of the UE described above in connection with FIG. 2. In some aspects, the communication manager 140 includes a set of components, such as a TA determination component 1108, an overlap handling component 1110, or a combination thereof. Alternatively, the set of components may be separate and distinct from the communication manager 140. In some aspects, one or more components of the set of components may include or may be implemented within a controller/processor, a memory, or a combination thereof, of the UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive configuration information for a serving cell associated with a first TRP and for two or more other cells associated with two or more other TRPs, the serving cell and the two or more other cells being associated with a same component carrier. The reception component 1102 may receive a first timing advance configuration associated with the serving cell and a second one or more timing advance configurations associated with the two or more other cells. The transmission component 1104 may transmit an uplink communication in accordance with the first timing advance configuration or the second one or more timing advance configurations.

The TA determination component 1108 may determine a timing advance value for the serving cell based at least in part on the first timing advance configuration. The TA determination component 1108 may determine a timing advance value for a cell, of the two or more cells, based at least in part on the second one or more timing advance configurations.

The reception component 1102 may receive an activation of a non-serving cell to a cell from the two or more other cells.

The transmission component 1104 may transmit, to the cell, an uplink communication using a timing that is based at least in part on a timing advance command associated with the cell and a timing advance value that is associated with the cell, wherein the timing advance value is indicated by the second one or more timing advance configurations.

The reception component 1102 may receive an activation of a non-serving cell to a cell from the two or more other cells.

The transmission component 1104 may transmit, to the cell, an uplink communication using timing that is based at least in part on a timing advance command associated with the cell and a timing advance value that is associated with a previously active non-serving cell from the two or more other cells.

The transmission component 1104 may transmit the first uplink communication using the first set of time domain resources. The transmission component 1104 may transmit the second uplink communication using the second set of time domain resources.

The transmission component 1104 may transmit a reduced uplink communication, from the first uplink communication or the second uplink communication, using a reduced set of time domain resources to cause the first set of time domain resources and the second set of time domain resources to not overlap.

The overlap handling component 1110 may identify the reduced uplink communication from the first uplink communication and the second uplink communication.

The quantity and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally or alternatively, a set of (one or more) components shown in FIG. 11 may perform one or more functions described as being performed by another set of components shown in FIG. 11.

FIG. 12 is a diagram of an example apparatus 1200 for wireless communication in accordance with the present disclosure. The apparatus 1200 may be a network entity, or a network entity may include the apparatus 1200. In some aspects, the apparatus 1200 includes a reception component 1202, a transmission component 1204, and a communication manager 1208, which may be in communication with one another (for example, via one or more buses). In some aspects, the communication manager 1208 may include one or more antennas, a modem, a controller/processor, a memory, or a combination thereof, of the base station described in connection with FIG. 2. The communication manager 1208 may be, or be similar to, the communication manager 150 depicted in FIGS. 1 and 2. For example, in some aspects, the communication manager 1208 may be configured to perform one or more of the functions described as being performed by the communication manager 150. In some aspects, the communication manager 1208 may include the reception component 1202 or the transmission component 1204. As shown, the apparatus 1200 may communicate with another apparatus 1206 (such as a UE, a base station, or another wireless communication device) using the reception component 1202 and the transmission component 1204.

In some aspects, the apparatus 1200 may be configured to perform one or more operations described herein in connection with FIGS. 7 and 8. Additionally or alternatively, the apparatus 1200 may be configured to perform one or more processes described herein, such as process 1000 of FIG. 10, or a combination thereof. In some aspects, the apparatus 1200 may include one or more components of the base station described above in connection with FIG. 2.

The reception component 1202 may receive communications, such as reference signals, control information, data communications, or a combination thereof, from the apparatus 1206. The reception component 1202 may provide received communications to one or more other components of the apparatus 1200, such as the communication manager 1208. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1202 may include one or more antennas, a modem, a demodulator, a MIMO detector, a receive processor, a controller/processor, a memory, or a combination thereof, of the base station described above in connection with FIG. 2.

The transmission component 1204 may transmit communications, such as reference signals, control information, data communications, or a combination thereof, to the apparatus 1206. In some aspects, the communication manager 1208 may generate communications and may transmit the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the base station described above in connection with FIG. 2. In some aspects, the transmission component 1204 may be co-located with the reception component 1202 in a transceiver.

The communication manager 1208 may transmit or may cause the transmission component 1204 to transmit, to a UE, configuration information for a serving cell associated with a first TRP and for two or more other cells being associated with two or more other TRPs, the serving cell and the two or more other cells associated with a same component carrier. The communication manager 1208 may transmit or may cause the transmission component 1204 to transmit, to the UE, a first timing advance configuration associated with the serving cell and a second one or more timing advance configurations associated with the two or more other cells. The communication manager 1208 may receive, or may cause the reception component 1202 to receive, an uplink communication in accordance with the first timing advance configuration or the second one or more timing advance configurations. In some aspects, the communication manager 1208 may perform one or more operations described elsewhere herein as being performed by one or more components of the communication manager 1208.

The communication manager 1208 may include a controller/processor, a memory, a scheduler, a communication unit, or a combination thereof, of the base station described above in connection with FIG. 2. In some aspects, the communication manager 1208 includes a set of components, such as a TA configuration determination component 1210, or a combination thereof. Alternatively, the set of components may be separate and distinct from the communication manager 1208. In some aspects, one or more components of the set of components may include or may be implemented within a controller/processor, a memory, a scheduler, a communication unit, or a combination thereof, of the base station described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The transmission component 1204 may transmit, to a UE, configuration information for a serving cell associated with a first TRP and for two or more other cells associated with two or more other TRPs, the serving cell and the two or more other cells being associated with a same component carrier. The transmission component 1204 may transmit, to the UE, a first timing advance configuration associated with the serving cell and a second one or more timing advance configurations associated with the two or more other cells. The reception component 1202 may receive an uplink communication in accordance with the first timing advance configuration or the second one or more timing advance configurations.

The TA configuration determination component 1210 may determine the first timing advance configuration. The TA configuration determination component 1210 may determine the second one or more timing advance configurations.

The transmission component 1204 may transmit an activation of a non-serving cell to a cell from the two or more other cells.

The reception component 1202 may receive, from the UE, an uplink communication using a timing that is based at least in part on a timing advance command associated with the cell and a timing advance value that is associated with the cell, wherein the timing advance value is indicated by the second one or more timing advance configurations.

The transmission component 1204 may transmit an activation of a non-serving cell to a cell from the two or more other cells.

The reception component 1202 may receive, from the UE, an uplink communication using timing that is based at least in part on a timing advance command associated with the cell and a timing advance value that is associated with a previously active non-serving cell from the two or more other cells.

The reception component 1202 may receive the first uplink communication using the first set of time domain resources. The reception component 1202 may receive the second uplink communication using the second set of time domain resources.

The reception component 1202 may receive a reduced uplink communication, from the first uplink communication or the second uplink communication, using a reduced set of time domain resources to cause the first set of time domain resources and the second set of time domain resources to not overlap.

The quantity and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: receiving configuration information for a serving cell associated with a first transmission reception point (TRP) and for two or more other cells associated with two or more other TRPs, the serving cell and the two or more other cells associated with a same component carrier; receiving a first timing advance configuration associated with the serving cell and a second one or more timing advance configurations associated with the two or more other cells; and transmitting an uplink communication in accordance with the first timing advance configuration or the second one or more timing advance configurations.

Aspect 2: The method of Aspect 1, wherein the serving cell is associated with a first physical cell identifier (PCI) and the two or more other cells are associated with two or more other PCIs.

Aspect 3: The method of any of Aspects 1-2, wherein receiving the second one or more timing advance configurations comprises receiving a separate respective timing advance configuration for each cell included in the two or more other cells.

Aspect 4: The method of any of Aspects 1-2, wherein receiving the second one or more timing advance configurations comprises receiving a single timing advance configuration that is associated with each cell included in the two or more other cells.

Aspect 5: The method of any of Aspects 1-4, further comprising: receiving an activation message that activates a non-serving cell, wherein the non-serving cell is a cell from the two or more other cells; receiving, from the cell, a timing advance command; and transmitting, to the cell, an uplink communication using a timing that is based at least in part on the timing advance command and a timing advance value that is associated with the cell, wherein the timing advance value is indicated by the second one or more timing advance configurations.

Aspect 6: The method of any of Aspects 1-4, further comprising: receiving an activation message that activates a non-serving cell, wherein the non-serving cell is a cell from the two or more other cells; receiving, from the cell, a timing advance command; and transmitting, to the cell, an uplink communication using a timing that is based at least in part on the timing advance command and a timing advance value that is associated with a previously active non-serving cell from the two or more other cells.

Aspect 7: The method of any of Aspects 1-6, wherein the second one or more timing advance configurations include one or more timing advance group (TAG) configurations, the method further comprising receiving an activation message that activates a TAG configuration from the one or more TAG configurations.

Aspect 8: The method of Aspect 7, wherein receiving the activation message that activates the TAG configuration comprises receiving a medium access control (MAC) control element (MAC-CE) message activating the TAG configuration for a physical cell identifier (PCI) of at least one of the two or more other cells.

Aspect 9: The method of Aspect 7, wherein receiving the activation message that activates the TAG configuration comprises receiving downlink control information activating the TAG configuration for a physical cell identifier (PCI) of at least one of the two or more other cells.

Aspect 10: The method of Aspect 7, wherein the TAG configuration is associated with a cell of the two or more other cells, wherein the cell is associated with a physical cell identifier (PCI), and wherein receiving the activation message that activates the TAG configuration comprises: receiving a transmission configuration indicator (TCI) state activation for a TCI state associated with the PCI of the cell, wherein the TCI state activation for the TCI state associated with the PCI of the cell indicates that the TAG configuration associated with the cell is activated.

Aspect 11: The method of Aspect 10, wherein the TCI state activation is included in a medium access control (MAC) control element (MAC) message or a downlink control information message.

Aspect 12: The method of any of Aspects 1-11, wherein the first timing advance configuration is associated with a first timing advance group (TAG) identifier, wherein a non-serving cell, from the two or more other cells, is activated and is associated with a timing advance configuration, from the second one or more timing advance configurations, that is associated with a second TAG identifier, the method further comprising: receiving first downlink control information scheduling a first uplink communication to use a first set of time domain resources; and receiving second downlink control information scheduling a second uplink communication to use a second set of time domain resources, wherein the first set of time domain resources and the second set of time domain resources at least partially overlap in a time domain based on an applied timing advance value.

Aspect 13: The method of Aspect 12, wherein the second set of time domain resources start at a later time than the first set of time domain resources, and transmitting the uplink communication comprises: transmitting the first uplink communication using the first set of time domain resources; and transmitting the second uplink communication using a reduced set of time domain resources from the second set of time domain resources, wherein the reduced set of time domain resources are reduced to not overlap with the first set of time domain resources.

Aspect 14: The method of Aspect 13, wherein transmitting the second uplink communication using the reduced set of time domain resources is based at least in part on at least one of: the first TAG identifier being the same as the second TAG identifier, the first uplink communication and the second uplink communication being incompatible for simultaneous transmissions, or the UE not supporting a capability for simultaneous transmissions.

Aspect 15: The method of Aspect 12, wherein transmitting the uplink communication comprises: transmitting the first uplink communication using the first set of time domain resources; and transmitting the second uplink communication using the second set of time domain resources.

Aspect 16: The method of Aspect 15, wherein transmitting the first uplink communication using the first set of time domain resources and transmitting the second uplink communication using the second set of time domain resources is based at least in part on at least one of: the first TAG identifier being different than the second TAG identifier; or the UE supporting a capability for simultaneous transmissions.

Aspect 17: The method of any of Aspects 12-14, wherein transmitting the uplink communication comprises: transmitting a reduced uplink communication, from the first uplink communication or the second uplink communication, using a reduced set of time domain resources to cause the first set of time domain resources and the second set of time domain resources to not overlap.

Aspect 18: The method of Aspect 17, wherein the reduced uplink communication is identified, from the first uplink communication or the second uplink communication, based at least in part on a first starting time of the first set of time domain resources and a second starting time of the second set of time domain resources.

Aspect 19: The method of any of Aspects 17-18, wherein the reduced uplink communication is identified, from the first uplink communication or the second uplink communication, based at least in part on a first priority associated with the first uplink communication and a second priority associated with the second uplink communication.

Aspect 20: The method of Aspect 19, wherein the first priority and the second priority are based at least in part on at least one of: a physical (PHY) layer priority, an uplink channel type, or a scheduling signaling type.

Aspect 21: The method of any of Aspects 17-20, wherein the reduced uplink communication is identified, from the first uplink communication or the second uplink communication, based at least in part on the first TAG identifier and the second TAG identifier.

Aspect 22: A method of wireless communication performed by a network entity, comprising: transmitting, to a user equipment (UE), configuration information for a serving cell associated with a first transmission reception point (TRP) and for two or more other cells associated with two or more other TRPs, the serving cell and the two or more other cells associated with a same component carrier; transmitting, to the UE, a first timing advance configuration associated with the serving cell and a second one or more timing advance configurations associated with the two or more other cells; and receiving an uplink communication in accordance with the first timing advance configuration or the second one or more timing advance configurations.

Aspect 23: The method of Aspect 22, wherein the serving cell is associated with a first physical cell identifier (PCI) and the two or more other cells are associated with two or more other PCIs.

Aspect 24: The method of any of Aspects 22-23, wherein transmitting the second one or more timing advance configurations comprises transmitting a separate respective timing advance configuration for each cell included in the two or more other cells.

Aspect 25: The method of any of Aspects 22-23, wherein transmitting the second one or more timing advance configurations comprises transmitting a single timing advance configuration that is associated with each cell included in the two or more other cells.

Aspect 26: The method of any of Aspects 22-25, further comprising: transmitting an activation message that activates a non-serving cell, wherein the non-serving cell is a cell from the two or more other cells; and receiving, from the UE, an uplink communication using a timing that is based at least in part on a timing advance command associated with the cell and a timing advance value that is associated with the cell, wherein the timing advance value is indicated by the second one or more timing advance configurations.

Aspect 27: The method of any of Aspects 22-25, further comprising: transmitting an activation message that activates a non-serving cell, wherein the non-serving cell is a cell from the two or more other cells; and receiving, from the UE, an uplink communication using timing that is based at least in part on a timing advance command associated with the cell and a timing advance value that is associated with a previously active non-serving cell from the two or more other cells.

Aspect 28: The method of any of Aspects 22-28, wherein the second one or more timing advance configurations include one or more timing advance group (TAG) configurations, the method further comprising: transmitting, to the UE, an activation message that activates a TAG configuration from the one or more TAG configurations.

Aspect 29: The method of Aspect 28, wherein transmitting the activation message that activates the TAG configuration comprises transmitting a medium access control (MAC) control element (MAC-CE) message activating the TAG configuration for a physical cell identifier (PCI) of at least one of the two or more other cells.

Aspect 30: The method of Aspect 28, wherein transmitting the activation message that activates the TAG configuration comprises transmitting downlink control information activating the TAG configuration for a physical cell identifier (PCI) of at least one of the two or more other cells.

Aspect 31: The method of Aspect 28, wherein the TAG configuration is associated with a cell of the two or more other cells, wherein the cell is associated with a physical cell identifier (PCI), and wherein transmitting the activation message that activates the TAG configuration comprises: transmitting a transmission configuration indicator (TCI) state activation for a TCI state associated with the PCI of the cell, wherein the TCI state activation for the TCI state associated with the PCI of the cell indicates that the TAG configuration associated with the cell is activated.

Aspect 32: The method of Aspect 31, wherein the TCI state activation is included in a medium access control (MAC) control element (MAC) message or a downlink control information message.

Aspect 33: The method of any of Aspects 22-32, wherein the first timing advance configuration is associated with a first timing advance group (TAG) identifier, wherein a non-serving cell, from the two or more other cells, is activated and is associated with a timing advance configuration, from the second one or more timing advance configurations, that is associated with a second TAG identifier, the method further comprising: transmitting first downlink control information scheduling a first uplink communication to use a first set of time domain resources; and transmitting second downlink control information scheduling a second uplink communication to use a second set of time domain resources, wherein the first set of time domain resources and the second set of time domain resources at least partially overlap in a time domain based on a timing advance value applied by the UE.

Aspect 34: The method of Aspect 33, wherein the second set of time domain resources start at a later time than the first set of time domain resources, and wherein receiving the uplink communication comprises: receiving the first uplink communication using the first set of time domain resources; and receiving the second uplink communication using a reduced set of time domain resources from the second set of time domain resources, wherein the reduced set of time domain resources are reduced to not overlap with the first set of time domain resources.

Aspect 35: The method of Aspect 34, wherein receiving the second uplink communication using the reduced set of time domain resources is based at least in part on at least one of: the first TAG identifier being the same as the second TAG identifier, the first uplink communication and the second uplink communication being incompatible for simultaneous transmissions, or the UE not supporting a capability for simultaneous transmissions.

Aspect 36: The method of Aspect 33, wherein receiving the uplink communication comprises: receiving the first uplink communication using the first set of time domain resources; and receiving the second uplink communication using the second set of time domain resources.

Aspect 37: The method of Aspect 36, wherein receiving the first uplink communication using the first set of time domain resources and receiving the second uplink communication using the second set of time domain resources is based at least in part on at least one of: the first TAG identifier being different than the second TAG identifier; or the UE supporting a capability for simultaneous transmissions.

Aspect 38: The method of any of Aspects 33-35, wherein receiving the uplink communication comprises: receiving a reduced uplink communication, from the first uplink communication or the second uplink communication, using a reduced set of time domain resources to cause the first set of time domain resources and the second set of time domain resources to not overlap.

Aspect 39: The method of Aspect 38, wherein the reduced uplink communication is identified, from the first uplink communication or the second uplink communication, based at least in part on a first starting time of the first set of time domain resources and a second starting time of the second set of time domain resources.

Aspect 40: The method of any of Aspects 38-39, wherein the reduced uplink communication is identified, from the first uplink communication or the second uplink communication, based at least in part on a first priority associated with the first uplink communication and a second priority associated with the second uplink communication.

Aspect 41: The method of Aspect 40, wherein the first priority and the second priority are based at least in part on at least one of: a physical (PHY) layer priority, an uplink channel type, or a scheduling signaling type.

Aspect 42: The method of any of Aspects 38-41, wherein the reduced uplink communication is identified, from the first uplink communication or the second uplink communication, based at least in part on the first TAG identifier and the second TAG identifier.

Aspect 43: An apparatus for wireless communication at a device, comprising a processor; memory coupled with the processor; and instructions stored in the memory and executable by the processor to cause the apparatus to perform the method of one or more of Aspects 1-21.

Aspect 44: A device for wireless communication, comprising a memory and one or more processors coupled to the memory, the one or more processors configured to perform the method of one or more of Aspects 1-21.

Aspect 45: An apparatus for wireless communication, comprising at least one means for performing the method of one or more of Aspects 1-21.

Aspect 46: A non-transitory computer-readable medium storing code for wireless communication, the code comprising instructions executable by a processor to perform the method of one or more of Aspects 1-21.

Aspect 47: A non-transitory computer-readable medium storing a set of instructions for wireless communication, the set of instructions comprising one or more instructions that, when executed by one or more processors of a device, cause the device to perform the method of one or more of Aspects 1-21.

Aspect 48: An apparatus for wireless communication at a device, comprising a processor; memory coupled with the processor; and instructions stored in the memory and executable by the processor to cause the apparatus to perform the method of one or more of Aspects 22-42.

Aspect 49: A device for wireless communication, comprising a memory and one or more processors coupled to the memory, the one or more processors configured to perform the method of one or more of Aspects 22-42.

Aspect 50: An apparatus for wireless communication, comprising at least one means for performing the method of one or more of Aspects 22-42.

Aspect 51: A non-transitory computer-readable medium storing code for wireless communication, the code comprising instructions executable by a processor to perform the method of one or more of Aspects 22-42.

Aspect 52: A non-transitory computer-readable medium storing a set of instructions for wireless communication, the set of instructions comprising one or more instructions that, when executed by one or more processors of a device, cause the device to perform the method of one or more of Aspects 22-42.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, processor-readable code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, since those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

What is claimed is:

1. A user equipment (UE) for wireless communication, comprising:
at least one processor; and
at least one memory communicatively coupled with the at least one processor and storing processor-readable code that, when executed by the at least one processor, is configured to cause the UE to:
receive configuration information for a serving cell associated with a first transmission reception point (TRP) and for two or more other cells respectively associated with two or more other TRPs, the serving cell and the two or more other cells being associated with a same component carrier;
receive a first timing advance configuration associated with the serving cell and a second one or more timing advance configurations associated with the two or more other cells; and
transmit an uplink communication in accordance with the first timing advance configuration or the second one or more timing advance configurations.

2. The UE of claim 1, wherein, to cause the UE to receive the second one or more timing advance configurations, the processor-readable code, when executed by the at least one processor, is configured to cause the UE to receive a separate respective timing advance configuration for each cell included in the two or more other cells.

3. The UE of claim 1, wherein, to cause the UE to receive the second one or more timing advance configurations, the processor-readable code, when executed by the at least one processor, is configured to cause the UE to receive a single timing advance configuration that is associated with each cell included in the two or more other cells.

4. The UE of claim 1, wherein the at least one memory further stores processor-readable code that, when executed by the at least one processor, is configured to cause the UE to:
receive an activation message that activates a non-serving cell, wherein the non-serving cell is a cell from the two or more other cells;
receive, from the cell, a timing advance command; and
transmit, to the cell, an uplink communication using a timing that is based at least in part on the timing advance command and a timing advance value that is associated with the cell, wherein the timing advance value is indicated by the second one or more timing advance configurations.

5. The UE of claim 1, wherein the at least one memory further stores processor-readable code that, when executed by the at least one processor, is configured to cause the UE to:
receive an activation message that activates of a non-serving cell, wherein the non-serving cell is a cell from the two or more other cells;
receive, from the cell, a timing advance command; and
transmit, to the cell, an uplink communication using timing that is based at least in part on the timing advance command and a timing advance value that is associated with a previously active non-serving cell from the two or more other cells.

6. The UE of claim 1, wherein the second one or more timing advance configurations include one or more timing advance group (TAG) configurations, and wherein the at least one memory further stores processor-readable code that, when executed by the at least one processor, is configured to cause the UE to receive an activation message that activates a TAG configuration from the one or more TAG configurations.

7. The UE of claim 6, wherein, to cause the UE to receive the activation message that activates the TAG configuration, the processor-readable code, when executed by the at least one processor, is configured to cause the UE to receive a medium access control (MAC) control element (MAC-CE) message or downlink control information activating the TAG configuration for a physical cell identifier (PCI) of at least one of the two or more other cells.

8. The UE of claim 6, wherein the TAG configuration is associated with a cell of the two or more other cells, wherein the cell is associated with a physical cell identifier (PCI), and wherein, to cause the UE to receive the activation message that activates the TAG configuration, the processor-readable code, when executed by the at least one processor, is configured to cause the UE to:
receive a transmission configuration indicator (TCI) state activation for a TCI state associated with the PCI of the cell, wherein the TCI state activation for the TCI state associated with the PCI of the cell indicates that the TAG configuration associated with the cell is activated.

9. The UE of claim 1, wherein the first timing advance configuration is associated with a first timing advance group (TAG) identifier, wherein a non-serving cell, from the two or more other cells, is activated and is associated with a timing advance configuration, from the second one or more timing advance configurations, that is associated with a second TAG identifier, and wherein the at least one memory further stores processor-readable code that, when executed by the at least one processor, is configured to cause the UE to:
receive first downlink control information scheduling a first uplink communication to use a first set of time domain resources; and
receive second downlink control information scheduling a second uplink communication to use a second set of time domain resources, wherein the first set of time domain resources and the second set of time domain resources at least partially overlap in a time domain based on an applied timing advance value.

10. The UE of claim 9, wherein the second set of time domain resources start at a later time than the first set of time domain resources, and wherein, to cause the UE to transmit the uplink communication, the processor-readable code that, when executed by the at least one processor, is configured to cause the UE to:
transmit the first uplink communication using the first set of time domain resources; and
transmit the second uplink communication using a reduced set of time domain resources from the second set of time domain resources, wherein the reduced set of time domain resources are reduced to not overlap with the first set of time domain resources.

11. The UE of claim 10, wherein transmitting the second uplink communication using the reduced set of time domain resources is based at least in part on at least one of:
the first TAG identifier being the same as the second TAG identifier,
the first uplink communication and the second uplink communication being incompatible for simultaneous transmissions, or
the UE not supporting a capability for simultaneous transmissions.

12. The UE of claim 9, wherein, to cause the UE to transmit the uplink communication, the processor-readable code that, when executed by the at least one processor, is configured to cause the UE to:
transmit the first uplink communication using the first set of time domain resources; and
transmit the second uplink communication using the second set of time domain resources.

13. The UE of claim 12, wherein transmitting the first uplink communication using the first set of time domain resources and transmitting the second uplink communication using the second set of time domain resources is based at least in part on at least one of:
the first TAG identifier being different than the second TAG identifier; or
the UE supporting a capability for simultaneous transmissions.

14. A method of wireless communication performed by a user equipment (UE), comprising:
receiving configuration information for a serving cell associated with a first transmission reception point (TRP) and for two or more other cells associated with two or more other TRPs, the serving cell and the two or more other cells being associated with a same component carrier;
receiving a first timing advance configuration associated with the serving cell and a second one or more timing advance configurations associated with the two or more other cells; and
transmitting an uplink communication in accordance with the first timing advance configuration or the second one or more timing advance configurations.

15. The method of claim 14, wherein receiving the second one or more timing advance configurations comprises receiving a separate respective timing advance configuration for each cell included in the two or more other cells.

16. The method of claim 14, wherein receiving the second one or more timing advance configurations comprises receiving a single timing advance configuration that is associated with each cell included in the two or more other cells.

17. The method of claim 14, further comprising:
receiving an activation message that activates a non-serving cell, wherein the non-serving cell is a cell from the two or more other cells;
receiving, from the cell, a timing advance command; and
transmitting, to the cell, an uplink communication using a timing that is based at least in part on the timing advance command and a timing advance value that is associated with the cell, wherein the timing advance value is indicated by the second one or more timing advance configurations.

18. The method of claim 14, further comprising:
receiving an activation message that activates a non-serving cell, wherein the non-serving cell is a cell from the two or more other cells;
receiving, from the cell, a timing advance command; and
transmitting, to the cell, an uplink communication using timing that is based at least in part on the timing advance command and a timing advance value that is associated with a previously active non-serving cell from the two or more other cells.

19. The method of claim 14, wherein the second one or more timing advance configurations include one or more timing advance group (TAG) configurations, the method further comprising receiving an activation message that activates a TAG configuration from the one or more TAG configurations.

20. The method of claim 19, wherein receiving the activation message that activates the TAG configuration comprises receiving a medium access control (MAC) control element (MAC-CE) message or downlink control information activating the TAG configuration for a physical cell identifier (PCI) of at least one of the two or more other cells.

21. The method of claim 19, wherein the TAG configuration is associated with a cell of the two or more other cells, wherein the cell is associated with a physical cell identifier (PCI), and wherein receiving the activation message that activates the TAG configuration comprises:
receiving a transmission configuration indicator (TCI) state activation for a TCI state associated with the PCI of the cell, wherein the TCI state activation for the TCI state associated with the PCI of the cell indicates that the TAG configuration associated with the cell is activated.

22. The method of claim 14, wherein the first timing advance configuration is associated with a first timing advance group (TAG) identifier, wherein a non-serving cell, from the two or more other cells, is activated and is associated with a timing advance configuration, from the second one or more timing advance configurations, that is associated with a second TAG identifier, the method further comprising:
receiving first downlink control information scheduling a first uplink communication to use a first set of time domain resources; and
receiving second downlink control information scheduling a second uplink communication to use a second set of time domain resources, wherein the first set of time domain resources and the second set of time domain resources at least partially overlap in a time domain based on an applied timing advance value.

23. The method of claim 22, wherein transmitting the uplink communication comprises:
transmitting the first uplink communication using the first set of time domain resources; and
transmitting the second uplink communication using the second set of time domain resources.

24. The method of claim 23, wherein transmitting the first uplink communication using the first set of time domain resources and transmitting the second uplink communication using the second set of time domain resources is based at least in part on at least one of:
the first TAG identifier being different than the second TAG identifier; or
the UE supporting a capability for simultaneous transmissions.

25. The method of claim 22, wherein transmitting the uplink communication comprises:
transmitting a reduced uplink communication, from the first uplink communication or the second uplink communication, using a reduced set of time domain resources to cause the first set of time domain resources and the second set of time domain resources to not overlap.

26. The method of claim 25, wherein the reduced uplink communication is identified, from the first uplink communication or the second uplink communication, based at least in part on at least one of:
a first starting time of the first set of time domain resources and a second starting time of the second set of time domain resources;
a first priority associated with the first uplink communication and a second priority associated with the second uplink communication; or
the first TAG identifier and the second TAG identifier.

27. A network entity for wireless communication, comprising:
at least one processor; and
at least one memory communicatively coupled with the at least one processor and storing processor-readable code that, when executed by the at least one processor, is configured to cause the network entity to:
transmit, to a user equipment (UE), configuration information for a serving cell associated with a first transmission reception point (TRP) and for two or more other cells associated with two or more other TRPs, the serving cell and the two or more other cells being associated with a same component carrier;
transmit, to the UE, a first timing advance configuration associated with the serving cell and a second one or more timing advance configurations associated with the two or more other cells; and
receive an uplink communication in accordance with the first timing advance configuration or the second one or more timing advance configurations.

28. The network entity of claim 27, wherein, to cause the network entity to transmit the second one or more timing advance configurations, the processor-readable code, when executed by the at least one processor, is configured to cause the network entity to:
transmit separate timing advance configurations for each cell included in the two or more other cells; or
transmit a single timing advance configuration that is associated with each cell included in the two or more other cells.

29. A method of wireless communication performed by a network entity, comprising:
transmitting, to a user equipment (UE), configuration information for a serving cell associated with a first transmission reception point (TRP) and for two or more other cells associated with two or more other TRPs, the serving cell and the two or more other cells being associated with a same component carrier;
transmitting, to the UE, a first timing advance configuration associated with the serving cell and a second one or more timing advance configurations associated with the two or more other cells; and
receiving an uplink communication in accordance with the first timing advance configuration or the second one or more timing advance configurations.

30. The method of claim 29, wherein transmitting the second one or more timing advance configurations comprises:
transmitting a separate respective timing advance configuration for each cell included in the two or more other cells; or
transmitting a single timing advance configuration that is associated with each cell included in the two or more other cells.
